(19) United States
(12) Patent Application Publication
(10) Pub. No.: US 2023/0407609 A1
(43) Pub. Date: Dec. 21, 2023

(54) ATMOSPHERIC WATER GENERATION SYSTEMS AND METHODS USING ELECTROSTATIC NUCLEATION OF WATER VAPOR IN AIR

(71) Applicant: Genesis Systems LLC, Tampa, FL (US)

(72) Inventors: David James Stuckenberg, Tampa, FL (US); Erick Keith Went, Camarillo, CA (US); Owen Michael Erickson, Largo, FL (US); Venkateswara Rao Kode, Tampa, FL (US)

(21) Appl. No.: 18/199,427

(22) Filed: May 19, 2023

Related U.S. Application Data
(60) Provisional application No. 63/364,991, filed on May 19, 2022.

(51) Int. Cl. E03B 3/28; B03C 3/017

(52) U.S. Cl. CPC E03B 3/28; B03C 3/017

(57) ABSTRACT

Described are a system, device, and method for atmospheric water generation (AWG). A device can include a nucleation chamber defining a cyclonic pathway therewithin. A humid gas is communicated along the cyclonic pathway within the nucleation chamber. Electrospray nozzle(s) is(are) used to disperse a nucleation initiator into the inner volume of the nucleation chamber to cause nucleation of water droplets from water vapor in the humid gas. The water droplets can be condensed out of the air to form an aqueous product. The nucleation initiator can be electrically charged before dispersion within the nucleation chamber to increase nucleation of water droplets from the humid gas. The nucleation initiator can comprise a salt, a desiccant material, a hygroscopic material, an ionic liquid, water droplets, CaCl₂, NaCl, LiCl, MgCl₂, KCOOH, CH₃COOK, or sulfates. Humid gas can be cooled to a temperature of between about 33° F. and about 75° F. before nucleation.

### CROSS-REFERENCE TO RELATED APPLICATIONS

This application claims the benefit of priority to U.S. Provisional Application Ser. No. 63/364,991, filed May 19, 2022 and entitled “Atmospheric Water Generation Systems and Methods of Using Electrostatic Nucleation of Water Vapor in Air,” the entire disclosure of which is hereby incorporated herein by reference in its entirety for all purposes.

This patent application additionally relates to U.S. patent application Ser. No. 17/690,550, filed Mar. 9, 2022, which claims priority from U.S. Provisional Appl. No. 63/158,676, filed Mar. 9, 2021; this patent application additionally relates to U.S. patent application Ser. No. 17/552,173, filed Dec. 15, 2021, which claims priority from U.S. Provisional Appl. Ser. No. 63/126,860, filed Dec. 17, 2020; this patent application additionally relates to U.S. patent application Ser. No. 16/782,808, filed Feb. 5, 2020, which is a continuation of U.S. patent application Ser. No. 15/850,870, filed Dec. 21, 2017, which claims priority from U.S. Provisional Application Ser. No. 62/437,471, filed Dec. 21, 2016; U.S. Provisional Application Ser. No. 62/459,462, filed Feb. 15, 2017; and U.S. Provisional Application Ser. No. 62/459,478, filed Feb. 15, 2017, all of which are incorporated herein by reference in their entireties.

### FIELD

The present disclosure relates, generally, to atmospheric water generation, and more specifically, to atmospheric water generation using a cyclonic nucleation chamber and an electrically charged nucleation initiator.

### BACKGROUND

The amount of freshwater available for human consumption, plant irrigation, livestock and herd sustenance, commercial and/or industrial usage, and other purposes has generally been overtaken by the amount of freshwater needed for such purposes. Particularly in arid climates characterized by minimal annual rainfall and without access to other freshwater sources, maintaining an adequate amount of water for human and/or animal consumption and usage has become increasingly expensive in recent years. Processes such as desalination, water filtration and/or purification, groundwater (e.g., aquifer) exploitation, and other processes are often used in combination to supply freshwater to various geographical regions, depending on the relative availability and expense of each water sourcing process.

Water shortages in certain geographical regions are also at least partially responsible for food shortages in certain areas of the globe. Where water is not readily available for crop irrigation and for hydrating livestock, basic nutritional foods may be difficult to cultivate, and may be difficult or expensive to procure in an open market.

Accordingly, a need generally exists for processes that expand the availability of freshwater, particularly in arid geographical areas and/or areas with no access to standing water or sub-surface water or in areas where such have become contaminated.

### BRIEF SUMMARY

Described are a system, device, and method for atmospheric water generation (AWG). A device can include a nucleation chamber defining a cyclonic pathway therewithin. A humid gas is communicated along the cyclonic pathway within the nucleation chamber. Electrospray nozzle(s) is(are) used to disperse a nucleation initiator into the inner volume of the nucleation chamber to cause nucleation of water droplets from water vapor in the humid gas. The water droplets can be condensed out of a gas flow/an air flow to form an aqueous product and at least partially dehumidify the gas flow/air flow. As used herein, the terms ‘gas’ and ‘air’ both refer to any gaseous fluid configured to carry water, water vapor, water droplets, moisture, and/or humidity therein. The nucleation initiator can be electrically charged before dispersion within the nucleation chamber to increase nucleation of water droplets from the humid gas. The nucleation initiator can comprise a salt, a desiccant material, a hygroscopic material, an ionic liquid, water droplets, CaCl₂, NaCl, LiCl, MgCl₂, KCOOH, CH₃COOK, sulfates, and/or the like. The humid gas can be cooled to between about 33° F. and about 75° F. before nucleation.

Various embodiments are directed to a water vapor separation technology for AWG by electrostatically inducing a charge on water droplets to create nucleation centers for encouraging water condensation, and using centripetal force (e.g., generated within a cyclone-inducing chamber) to accelerate water condensation. No thermal energy input and no usage of corrosive, toxic, and/or flammable materials are needed. An example embodiment comprises a cyclone chamber into which tiny nucleation initiator droplets, e.g., nucleation initiator droplets having a diameter of between about 1 micron and about 500 microns, are injected by high throughput electrospray nozzles (e.g., atomizer nozzles). In some embodiments, the nucleation initiator droplets have a diameter of less than about 500 microns, less than about 400 microns, less than about 300 microns, less than about 200 microns, less than about 100 microns, less than about 75 microns, less than about 50 microns, less than about 25 microns, less than about 10 microns, or less than about 5 microns, inclusive of all values and ranges therebetween. These micron-scale nucleation initiator droplets can be electrostatically charged to encourage nucleation and condensation of water vapor within a humid gas flow that is passed through the cyclonic nucleation chamber such that the AWG system produces liquid water and an at least partially dehumidified gas flow after condensation of the water vapor from within the humid gas flow.

According to an embodiment, an apparatus can be provided that includes means for carrying out AWG using a charged nucleation initiator. According to an embodiment, an AWG device can be provided that comprises: a nucleation chamber having an outer shell defining an inner volume; a first inlet through the outer shell of the nucleation chamber to direct a volume of a gas into a cyclonic pathway in the inner volume of the nucleation chamber; at least one electrospray nozzle positioned within the inner volume of the nucleation chamber, wherein the at least one electrospray nozzle is configured to disperse a nucleation initiator into the inner volume of the nucleation chamber to cause nucleation of water droplets from water vapor in the volume of gas about one or more particles or droplets of the nucleation initiator to form an aqueous product; and an aqueous product outlet disposed through the outer shell of the nucleation chamber, wherein the aqueous product outlet is configured to direct at least a portion of the aqueous product out of the nucleation chamber.

In some embodiments, the AWG device can further comprise: a separation module configured to separate the aqueous product into a water-based permeate and a concentrate. In some embodiments, the separation module comprises one or more of: membrane filtration, microfiltration, nanofiltration, ultrafiltration, reverse osmosis, forward osmosis, distillation, gas separation, electrodialysis, electrode ionization, electro filtration, fuel cell, membrane distillation, evaporation, crystallization, ion exchange, electrodialysis reversal, capacitive deionization, centrifugal separation, or graphene size-exclusion membrane filtration. In some embodiments, the nucleation initiator comprises a salt, a desiccant material, a hygroscopic material, an ionic liquid, or water droplets. In some embodiments, the AWG device can further comprise: a dehumidified air outlet formed through the outer shell of the nucleation chamber, the dehumidified air outlet being configured to communicate the volume of the gas out of the nucleation chamber. In some embodiments, the AWG device can further comprise: one or more carbon capture cartridges or carbon capture tanks in fluidic communication with the dehumidified air outlet and configured to remove carbon-containing materials from the volume of the gas after being communicated out of the nucleation chamber. In some embodiments, the cyclonic pathway is defined at least in part by a concave shape of an inner surface of the nucleation chamber. In some embodiments, the shape of the inner surface of the nucleation chamber is one or more of: cylindrical, conical, spherical, columnar, pyramidal, prismatic, cubic, a torus, polyhedra, an octagonal prism, tetrahedra, octahedra, dodecahedra, icosahedra, irregularly prismatic, or irregularly pyramidal.

In some embodiments, one or more electrospray nozzles are at least partially disposed in one or more apertures extending at least partially through the outer shell of the nucleation chamber. In some embodiments, each of the one or more electrospray nozzles define a plurality of channels formed therein, the plurality of channels being dimensioned and configured to communicate a portion of the quantity of the nucleation initiator into the inner volume of the nucleation chamber. In some embodiments, the one or more electrospray nozzles comprises a plurality of electrospray nozzles in a same plane, and wherein respective of the plurality of electrospray nozzles in the same plane are oriented in different directions. In some embodiments, the one or more electrospray nozzles comprise one or more electrodes configured to charge the nucleation initiator prior to or while dispersing the nucleation initiator into the inner volume of the nucleation chamber. In some embodiments, at least a portion of an inner surface of the nucleation chamber comprises or is coated with one of: a hydrophilic material, a hydrophobic material, a superhydrophobic material, an oleophobic material, an oleophilic material, a polymer, noble metals, rare-earth oxides, or organic monolayers.

In some embodiments, the AWG device can further comprise: a condensation region within a bottom portion of the inner volume of the nucleation chamber, wherein the condensation region is configured to cause condensation of the water droplets formed about the one or more particles or droplets of the nucleation initiator. In some embodiments, a geometry of the bottom portion of the inner volume of the nucleation chamber is configured to cause one of: drop-wise condensation, film-wise condensation, droplet aggregation, droplet gravity collection, droplet shear collection, or condensate film flow along a condensing surface. In some embodiments, a relative humidity of the volume of the gas is greater than about 30% before the volume of the gas is communicated into the inner volume of the nucleation chamber.

In some embodiments, the AWG device can further comprise: a cooling element/device configured to decrease a temperature of the volume of the gas to between about 33° F. and about F. In some embodiments, the nucleation initiator comprises one or more of: CaCl₂, NaCl, LiCl, MgCl₂, KCOOH, CH₃COOK, or sulfates. In some embodiments, the AWG device can further comprise: one or more condensation enhancement structures disposed within a bottom portion of the inner volume of the nucleation chamber, the one or more condensation enhancement structures configured to increase a rate of condensation of the water droplets formed about the one or more particles or droplets of the nucleation initiator. In some embodiments, the one or more condensation enhancement structures comprise one or more of: baffles, perforated baffles, plates, perforated plates, static mixers, tabs, columns, dividers, porous structures, vertical structures, textured surfaces, lubricious surfaces, or liquid-impregnated surfaces.

According to another embodiment, an AWG system can be provided that comprises: a nucleation chamber having an outer shell defining an inner volume, the nucleation chamber comprising: a first inlet through the outer shell of the nucleation chamber to direct a volume of a gas into a cyclonic pathway in the inner volume of the nucleation chamber; at least one electrospray nozzle positioned within the inner volume of the nucleation chamber, wherein at least one electrospray nozzle is configured to disperse a nucleation initiator into the inner volume of the nucleation chamber to cause nucleation of water droplets from water vapor in the volume of gas about one or more particles or droplets of the nucleation initiator to form an aqueous product; and an aqueous product outlet disposed through the outer shell of the nucleation chamber, wherein the aqueous product outlet is configured to direct at least a portion of the aqueous product out of the nucleation chamber; the AWG system further comprising a separation module in fluidic communication with the aqueous product outlet of the nucleation chamber, the separation module being configured to separate the aqueous product into a retentate and an aqueous filtrate, the retentate comprising at least a portion of the nucleation initiator.

In some embodiments, the separation module comprises one or more of: membrane filtration, microfiltration, nanofiltration, ultrafiltration, reverse osmosis, forward osmosis, distillation, gas separation, electrodialysis, electrode ionization, electro filtration, fuel cell, membrane distillation, evaporation, crystallization, ion exchange, electrodialysis reversal, capacitive deionization, centrifugal separation, or graphene size-exclusion membrane filtration. In some embodiments, the nucleation initiator comprises a salt, a desiccant material, a hygroscopic material, an ionic liquid, or water droplets. In some embodiments, the AWG system can further comprise: a dehumidified air outlet formed through the outer shell of the nucleation chamber, the dehumidified air outlet being configured to communicate the volume of the gas out of the nucleation chamber. In some embodiments, the AWG system can further comprise: one or more carbon capture cartridges or carbon capture tanks in fluidic communication with the dehumidified air outlet and configured to remove carbon-containing materials from the volume of the gas after being communicated out of the nucleation chamber.

In some embodiments, the cyclonic pathway is defined at least in part by a concave shape of an inner surface of the nucleation chamber. In some embodiments, the shape of the inner surface of the nucleation chamber is one or more of: cylindrical, conical, spherical, columnar, pyramidal, prismatic, cubic, a torus, polyhedra, an octagonal prism, tetrahedra, octahedra, dodecahedra, icosahedra, irregularly prismatic, or irregularly pyramidal. In some embodiments, one or more electrospray nozzles are at least partially disposed in one or more apertures extending at least partially through the outer shell of the nucleation chamber. In some embodiments, each of the one or more electrospray nozzles define a plurality of channels formed therein, the plurality of channels being dimensioned and configured to communicate a portion of the quantity of the nucleation initiator into the inner volume of the nucleation chamber. In some embodiments, the one or more electrospray nozzles comprises a plurality of electrospray nozzles in a same plane, and wherein respective of the plurality of electrospray nozzles in the same plane are oriented in different directions.

In some embodiments, the one or more electrospray nozzles comprise one or more electrodes configured to charge the nucleation initiator prior to or while dispersing the nucleation initiator into the inner volume of the nucleation chamber. In some embodiments, at least a portion of an inner surface of the nucleation chamber comprises or is coated with one of: a hydrophilic material, a hydrophobic material, a superhydrophobic material, an oleophobic material, an oleophilic material, a polymer, noble metals, rare-earth oxides, or organic monolayers. In some embodiments, the nucleation chamber further comprises: a condensation region within a bottom portion of the inner volume of the nucleation chamber, wherein the condensation region is configured to cause condensation of the water droplets formed about the one or more particles or droplets of the nucleation initiator. In some embodiments, a geometry of the bottom portion of the inner volume of the nucleation chamber is configured to cause one of: drop-wise condensation, film-wise condensation, droplet aggregation, droplet gravity collection, droplet shear collection, or condensate film flow along a condensing surface.

In some embodiments, a relative humidity of the volume of the gas is greater than about 30% before the volume of the gas is communicated into the inner volume of the nucleation chamber. In some embodiments, the nucleation chamber further comprises: a cooling element/device configured to decrease a temperature of the volume of the gas to between about 33° F. and about 75° F. In some embodiments, the nucleation initiator comprises one or more of: CaCl₂, NaCl, LiCl, MgCl₂, KCOOH, CH₃COOK, or sulfates. In some embodiments, the nucleation chamber further comprises: one or more condensation enhancement structures disposed within a bottom portion of the inner volume of the nucleation chamber, the one or more condensation enhancement structures configured to increase a rate of condensation of the water droplets formed about the one or more particles or droplets of the nucleation initiator. In some embodiments, the one or more condensation enhancement structures comprise one or more of: baffles, perforated baffles, plates, perforated plates, static mixers, tabs, columns, dividers, porous structures, vertical structures, textured surfaces, lubricious surfaces, or liquid-impregnated surfaces.

According to another embodiment, a method for atmospheric water generation (AWG) can be carried out, the method comprising: communicating a volume of a gas into an inner volume of a nucleation chamber such that the volume of the gas travels along a cyclonic pathway within the inner volume of the nucleation chamber; dispersing, using at least one electrospray nozzle positioned within the inner volume of the nucleation chamber, while the volume of the gas travels along the cyclonic pathway within the inner volume of the nucleation chamber, a nucleation initiator into the inner volume of the nucleation chamber, to cause nucleation of water droplets from water vapor in the volume of the gas about one or more particles or droplets of the nucleation initiator, thereby forming an aqueous product and a volume of dehumidified gas; communicating the volume of the dehumidified gas out of the nucleation chamber through a first outlet of the nucleation chamber; communicating the aqueous product out of the nucleation chamber through a second outlet of the nucleation chamber; and separating the aqueous product, using a separation module, after the aqueous product is communicated out of the nucleation chamber, into a retentate and an aqueous filtrate, the retentate comprising at least a portion of the nucleation initiator.

In some embodiments, the nucleation initiator comprises a salt, a desiccant material, a hygroscopic material, an ionic liquid, or water droplets. In some embodiments, the method can further comprise: capturing, using one or more carbon capture cartridges or carbon capture tanks in fluidic communication with the nucleation chamber, carbon-containing materials from the volume of the dehumidified gas after being communicated out of the nucleation chamber. In some embodiments, the cyclonic pathway is defined at least in part by a concave shape of an inner surface of the nucleation chamber.

In some embodiments, the method can further comprise: returning the portion of the nucleation initiator in the retentate to a nucleation initiator reservoir in fluidic communication with the nucleation chamber such that the portion of the nucleation initiator in the retentate is available to be dispersed again within the inner volume of the nucleation chamber to cause nucleation of water droplets from water vapor in a subsequent volume of the gas.

In some embodiments, the method can further comprise: electrically charging the nucleation initiator prior to dispersing the nucleation initiator into the inner volume of the nucleation chamber while the volume of the gas travels along the cyclonic pathway.

In some embodiments, the method can further comprise: condensing, in a condensation region within a bottom portion of the inner volume of the nucleation chamber, the water droplets formed about the one or more particles or droplets of the nucleation initiator, thereby forming the aqueous product.

In some embodiments, a relative humidity of the volume of the gas is greater than about 30%. In some embodiments, the relative humidity of the dehumidified gas is less than about 20%.

In some embodiments, the method can further comprise: cooling the volume of the gas, before the volume of the gas is communicated into the nucleation chamber, using a cooling element/device configured to decrease a temperature of the volume of the gas to between about 33° F. and about 75° F. In some embodiments, the nucleation initiator comprises one or more of: CaCl₂, NaCl, LiCl, MgCl₂, KCOOH, CH₃COOK, or sulfates.

### BRIEF DESCRIPTION OF THE DRAWINGS

Reference will now be made to the accompanying drawings, which are not necessarily drawn to scale, and wherein:

FIG. 1 illustrates an example AWG system, according to an embodiment described herein;

FIG. 2 illustrates an example AWG system, according to an embodiment described herein;

FIG. 3 illustrates an example AWG system, according to an embodiment described herein;

FIG. 4 illustrates an example nucleation cyclone, according to an embodiment described herein;

FIG. 5 illustrates an example nozzle configuration for nebulizing charged droplets of nucleation initiation materials, according to an embodiment described herein;

FIG. 6 illustrates an example AWG system, according to an embodiment described herein;

FIG. 7 illustrates an example AWG system, according to an embodiment described herein;

FIG. 8 an example AWG system, according to an embodiment described herein;

FIG. 9 an example AWG system, according to an embodiment described herein;

FIG. 10 illustrates an example AWG system, according to an embodiment described herein;

FIG. 11 is a block flow diagram of a method for atmospheric water generation, according to an embodiment described herein;

FIG. 12 is a block flow diagram of a method for atmospheric water generation, according to an embodiment described herein;

FIG. 13 is a block flow diagram of a method for atmospheric water generation, according to an embodiment described herein;

FIG. 14 is a block flow diagram of a method for atmospheric water generation, according to an embodiment described herein;

FIG. 15 is a block flow diagram of a method for atmospheric water generation, according to an embodiment described herein; and

FIG. 16 is a block flow diagram of a method for atmospheric water generation, according to an embodiment described herein.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

Atmospheric water generation (AWG) is a technology for extracting water from atmospheric air, which can be used for drinking, irrigation, and other purposes. The primary goal of AWG is to provide an alternative source of clean drinking water in areas where access to freshwater is limited or non-existent.

Approaches for AWG can, generally, be separated into two different categories of technologies, including passive AWG and active AWG. Passive AWG often relies on natural processes, such as natural condensation and dew formation, but are inefficient and ineffectual compared to active AWG. Active AWG often relies on substantial refrigeration and/or desiccants to extract water from the atmosphere, or other such water-carrying gases. Active AWG often relies on expensive or exotic materials, and often require a much greater energy/heat input than passive AWG approaches, however the resulting efficiency and efficacy of water extraction from the atmosphere or other gases is often much higher than passive AWG approaches.

Several different technologies currently characterize the active AWG approaches, including refrigeration-based AWG, desiccant-based AWG, membrane-based AWG, hygroscopic-based AWG, and photovoltaic-based (PV-based) AWG. Refrigeration-based approaches rely on cooling the air or other gas to initiate moisture condensation as water droplets on surfaces within a tank. Desiccant-based approaches rely on moisture absorbing materials to temporarily preferentially absorb moisture from the humid air, thereby at least partially dehumidifying the air, and then water is retrieved or extracted from the desiccant material. Membrane-based approaches rely on membranes that are permeable to the air/gases but impermeable or only partially permeable to the water vapor. Hygroscopic-based approaches use hygroscopic material to absorb the water vapor, followed by condensation or extraction of the water from the hygroscopic material. PV-based approaches rely on solar energy or power to extract water from air or other gases, but are often less efficient/effective than other active AWG approaches.

Existing active AWG systems have faced challenges including high energy demands associated with multiple water phase transitions to produce a unit of water. Water vapor is first extracted from air, typically into an intermediary fluid, such as a liquid desiccant or high-humidity gaseous phase via a highly energy intensive process. The water vapor is then extracted from the intermediary fluid into liquid water through another highly energy intensive process. Other systems incorporate cooled surfaces to cool the water vapor directly (without first extracting the water vapor into an intermediary fluid) to the dew point and extract liquid water on the cooled surface. Several attempts have been made to bring down the overall energy requirements of AWG systems; however, energy-reduction techniques remain limited by their feasibility for all-weather AWG conditions. Thus, alternative innovative technologies that generate water in an energy-efficient manner are sought.

Described herein are several embodiments of a system, device, and method for AWG.

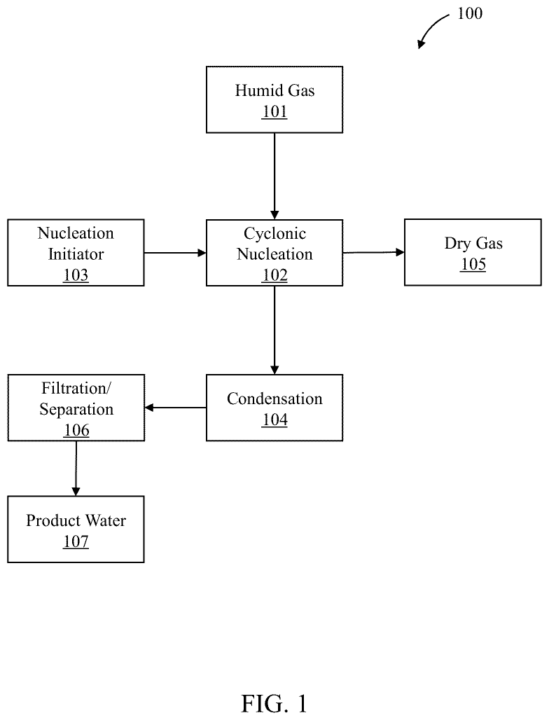

As illustrated in FIG. 1, an AWG process 100 is provided that avoids use of energy-inefficient processes, reduces or eliminates the use of desiccants and ionic liquids, and/or reduces the system footprint, according to an embodiment. The AWG process 100 includes communicating a humid gas 101 from a humid gas source to a cyclonic nucleation chamber for cyclonic nucleation 102. The humid gas 101 can have a humidity, e.g., of about 30% or more. The humid gas 101 can be cooled to a temperature of between about 33° F. and about 75° F. The humid gas 101 can be disposed into the cyclonic nucleation chamber at any suitable angle, trajectory, rate, jet size, distance from an inner surface of the cyclonic nucleation chamber, or otherwise, in order to initiate a cyclonic pathway within the inner volume of the cyclonic nucleation chamber.

A nucleation initiator 103 can then be introduced into the cyclonic nucleation chamber to initiate the cyclonic nucleation 102 of water droplets from the humid gas 101. The nucleation initiator 103 can include any suitable material that is configured to initiate nucleation of water droplets from water vapor in the humid gas. For example, the nucleation initiator 103 can include a salt, a desiccant material, a hygroscopic material, an ionic liquid, water droplets, CaCl₂, NaCl, LiCl, MgCl₂, KCOOH, CH₃COOK, sulfates, other suitable materials, variations thereof, and/or combinations thereof. The nucleation initiator 103 described herein can comprise or be embodied by droplets of the nucleation initiator 103 having a diameter of between about 1 micron and about 500 microns. In some embodiments, the nucleation initiator 103 comprises a mist, a cloud, a fog, a spray, a vapor, and/or a stream of micron sized particles of the nucleation initiator 103 that can be injected by high throughput electrospray nozzles (e.g., atomizer nozzles). In some embodiments, the nucleation initiator 103 can comprise droplets having a maximum dimension (e.g., a diameter) of less than about 500 microns, less than about 400 microns, less than about 300 microns, less than about 200 microns, less than about 100 microns, less than about 75 microns, less than about 50 microns, less than about 25 microns, less than about 10 microns, or less than about 5 microns, inclusive of all values and ranges therebetween.

The nucleation initiator 103 can be introduced into the cyclonic nucleation chamber to initiate cyclonic nucleation 102 of water droplets from water vapor in the humid gas 101 using one or more electrospray nozzle(s) positioned within the inner volume of the cyclic nucleation chamber. The electrospray nozzle(s) can be configured to disperse, spray, scatter, diffuse, spray, or otherwise dispose the nucleation initiator 103 into the inner volume of the cyclic nucleation chamber. The nucleation initiator 103 can be disposed within or about the humid gas 101 when the humid gas 101 is communicated into the cyclonic nucleation chamber, after the humid gas 101 is communicated into the cyclonic nucleation chamber, and/or at any point along the cyclonic pathway within the inner volume of the cyclonic nucleation chamber.

Without wishing to be bound by any particular theory, cyclonic nucleation 102 of the humid gas 101 can cause water droplets to form about particles or droplets of the nucleation initiator 103. The water droplets can then be separated from the humid gas 101 via condensation 104. Condensation 104 can be carried out by any suitable means, such as by way of a cooling process, a high-surface area contact process, a direct diffusion process, a chemical condensation process, other suitable processes, and/or the like. For example, a bottom portion of the cyclonic nucleation chamber can be dimensioned such that water droplets that contact the bottom portion of the cyclonic nucleation chamber, through surface tension or the like, can adsorb to the inner surface, accumulate, and gravity feed to a collection point or an outlet of the cyclonic nucleation chamber. Condensation 104 can lead to the formation of an aqueous solution that comprises at least a portion of the nucleation initiator 103 and the accumulated water from condensed water vapor.

Condensation 104 can also lead to the formation of dry gas 105. The dry gas 105 may be dry as defined by having a humidity below a particular relative humidity threshold, compared to a relative humidity of the humid gas 101, or otherwise. For example, the humid gas 101 can have a relative humidity of greater than about 30%, while the dry gas 105 can have a relative humidity of less than about 20%. In some embodiments, the humid gas 101 can have a relative humidity of between about 30% and about 100%, while the dry gas 105 can have a relative humidity of between 0% and about 20%, inclusive of all values and ranges therebetween.

While condensation 104 can result in relative dehumidification of the humid gas 101, forming the dry gas 105, the aqueous solution formed from condensation 104 that includes at least a portion of the nucleation initiator 103 may not be usable as product water because of the presence of the nucleation initiator 103 in the aqueous solution, a temperature of the aqueous solution, the presence of impurities, and/or the like. Further, the aqueous solution formed from condensation 104 that includes at least a portion of the nucleation initiator 103 may not be usable to replenish a reservoir of the nucleation initiator 103 because the concentration of the nucleation initiator 103 in the aqueous solution is not sufficiently high, a temperature of the aqueous solution, the presence of impurities, and/or the like.

The aqueous solution formed from condensation 104 can then undergo filtration and/or separation 106. Filtration and/or separation 106 can be carried out using any suitable membrane, filter, exchange bed, separation process, and/or the like. For example, filtration and/or separation 106 can comprise one or more of: membrane filtration, microfiltration, nanofiltration, ultrafiltration, reverse osmosis, forward osmosis, distillation, gas separation, electrodialysis, electrode ionization, electro filtration, fuel cell, membrane distillation, evaporation, crystallization, ion exchange, electrodialysis reversal, capacitive deionization, centrifugal separation, or graphene size-exclusion membrane filtration. In some embodiments, filtration and/or separation 106 produces a water-based permeate (or filtrate) and a concentrate (or retentate). If the permeate has a sufficiently low concentration of undesirable materials or compounds, such as the nucleation initiator 103 or impurities, the permeate may be used as product water 107 in the same or a different process, system, or facility.

In some embodiments, the concentrate may have a sufficiently high concentration of the nucleation initiator 103 such that the concentrate can be returned directly for use as the nucleation initiator 103 for cyclonic nucleation 102 of a subsequent volume of humid gas 101. In some embodiments, the concentrate may have a concentration of the nucleation initiator 103 that is not sufficiently high for the concentrate to be returned directly for use as the nucleation initiator 103 for cyclonic nucleation 102 of a subsequent volume of the humid gas 101. In either or both cases, it may be needed to make up some percentage of loss of the nucleation initiator 103 at a reservoir of the same.

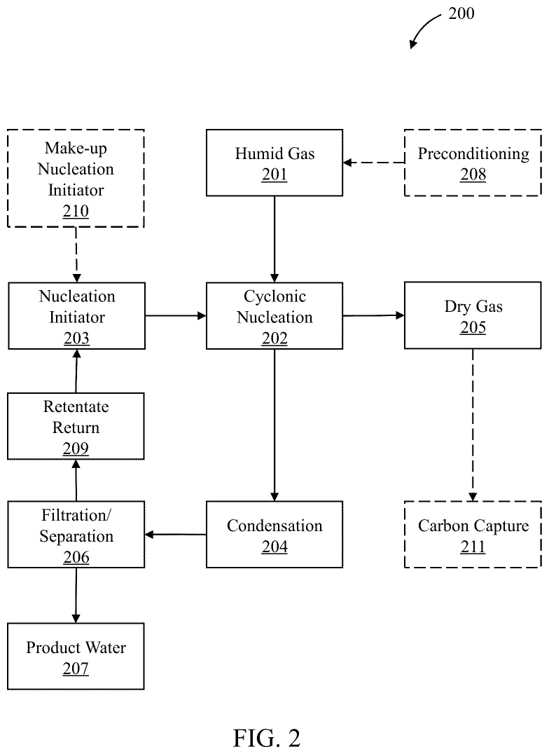

Referring now to FIG. 2, an AWG process 200 is illustrated. Various aspects/steps of the AWG process 200 can be similar to or identical to aspects/steps of the AWG process 100. However, other aspects/steps of the AWG process 200 can be dissimilar to those of the AWG process 100 or additional to those described above regarding the AWG process 100 and illustrated in corresponding FIG. 1.

The AWG process 200 can include communicating a humid gas 201 from a humid gas source to a cyclonic nucleation chamber for cyclonic nucleation 202. The humid gas 201 can have a humidity, e.g., of about 30% or more. The humid gas 201 can be disposed into the cyclonic nucleation chamber at any suitable angle, trajectory, rate, jet size, distance from an inner surface of the cyclonic nucleation chamber, or otherwise, in order to initiate a cyclonic pathway within the inner volume of the cyclonic nucleation chamber.

A nucleation initiator 203 can then be introduced into the cyclonic nucleation chamber to initiate the cyclonic nucleation 202 of water droplets from the humid gas 201. The nucleation initiator 203 can include any suitable material that is configured to initiate nucleation of water droplets from water vapor in the humid gas 201. For example, the nucleation initiator 203 can include a salt, a desiccant material, a hygroscopic material, an ionic liquid, water droplets, CaCl₂, NaCl, LiCl, MgCl₂, KCOOH, CH₃COOK, sulfates, other suitable materials, variations thereof, and/or combinations thereof.

The nucleation initiator 203 can be introduced into the cyclonic nucleation chamber to initiate cyclonic nucleation 202 of water droplets from water vapor in the humid gas 201 using one or more electrospray nozzle(s) positioned within the inner volume of the cyclic nucleation chamber. The electrospray nozzle(s) can be configured to disperse, spray, scatter, diffuse, atomize, or otherwise communicate the nucleation initiator 203 into the inner volume of the cyclic nucleation chamber. The nucleation initiator 203 can be disposed within or about the humid gas 201 when the humid gas 201 is communicated into the cyclonic nucleation chamber, after the humid gas 201 is communicated into the cyclonic nucleation chamber, and/or at any point along the cyclonic pathway within the inner volume of the cyclonic nucleation chamber.

Without wishing to be bound by any particular theory, cyclonic nucleation 202 of the humid gas 201 can cause water droplets to form about particles or droplets of the nucleation initiator 203. The water droplets can then be separated from the humid gas 201 via condensation 204. Condensation 204 can be carried out by any suitable means, such as by way of a cooling process, a high-surface area contact process, a direct diffusion process, a chemical condensation process, other suitable processes, and/or the like. For example, a bottom portion of the cyclonic nucleation chamber can be dimensioned such that water droplets that contact the bottom portion of the cyclonic nucleation chamber, through surface tension or the like, can adsorb to the inner surface, accumulate, and gravity feed to a collection point or an outlet of the cyclonic nucleation chamber. Condensation 204 can lead to the formation of an aqueous solution that comprises at least a portion of the nucleation initiator 203 and the accumulated water from condensed water vapor.

Condensation 204 can also lead to the formation of dry gas 205. The dry gas 205 may be dry, defined as having a humidity below a particular relative humidity threshold, compared to a relative humidity of the humid gas 201, or otherwise. For example, the humid gas 201 can have a relative humidity of greater than about 30%, while the dry gas 205 can have a relative humidity of less than about 20%. In some embodiments, if the dry gas 205 does not have a sufficiently low relative humidity and/or a relative humidity below a particular relative humidity threshold, some or all of the dry gas 205 can be recycled/returned to the intake port of the cyclonic nucleation chamber in order to further nucleate and remove water droplets from the dry gas 205 for one or more recycle/return cycles, and/or until the relative humidity of the dry gas 205 is sufficiently low or below the particular relative humidity threshold.

While condensation 204 can result in relative dehumidification of the humid gas 201, forming the dry gas 205, the aqueous solution formed from condensation 204 that includes at least a portion of the nucleation initiator 203 may not be usable as product water because of the presence of the nucleation initiator 203 in the aqueous solution, a temperature of the aqueous solution, the presence of impurities, and/or the like. Further, the aqueous solution formed from condensation 204 that includes at least a portion of the nucleation initiator 203 may not be usable to replenish a reservoir of the nucleation initiator 203 because the concentration of the nucleation initiator 203 in the aqueous solution is not sufficiently high, a temperature of the aqueous solution, the presence of impurities, and/or the like.

Various embodiments utilize a membrane-separation module to separate the water from the desiccant solution. The membrane separation module defines two flow paths separated by a permeable membrane. The desiccant solution (a diluted desiccant solution after absorbing water from atmospheric air) flows on a first side of the permeable membrane and permeate water (e.g., in liquid form and/or in vapor form) flows on a second side of the permeable membrane. Water (e.g., water vapor) can penetrate the permeable membrane from the first side to the second side of the permeable membrane. The desiccant solution remains on the first side of the membrane and water remains on the second side of the membrane. The membrane-separation module may additionally enable control of the environmental conditions within the membrane-separation module to encourage mass flow of water across the permeable membrane from the desiccant solution on the first side of the membrane and into the flow of water (liquid water and/or water vapor) on the second side of the membrane. For example, the temperature and pressure may be increased on the first side of the membrane (e.g., by increasing the temperature and/or pressure of the desiccant solution flowing into the membrane separation module) and the temperature and pressure may be decreased on the second side of the membrane (e.g., by decreasing the temperature and/or pressure of the water flow on the second side of the membrane). Certain embodiments may comprise multiple membrane separation modules operating in series or in parallel and/or may comprise additional systems for extracting water from the desiccant solution.

For example, as illustrated in FIG. 2, the aqueous solution formed from condensation 204 can then undergo filtration and/or separation 206. Filtration and/or separation 206 can be carried out using any suitable membrane, filter, exchange bed, separation process, and/or the like. For example, filtration and/or separation 206 can comprise one or more of: membrane filtration, microfiltration, nanofiltration, ultrafiltration, reverse osmosis, forward osmosis, distillation, gas separation, electrodialysis, electrode ionization, electro filtration, fuel cell, membrane distillation, evaporation, crystallization, ion exchange, electrodialysis reversal, capacitive deionization, centrifugal separation, or graphene size-exclusion membrane filtration. In some embodiments, filtration and/or separation 206 can produce a water-based permeate (or filtrate) and a concentrate (or retentate). If the permeate has a sufficiently low concentration of undesirable materials or compounds, such as the nucleation initiator 203 or impurities, the permeate may be used as product water 207 in the same or a different process, system, or facility.

In some embodiments, the humid gas 201 can, optionally, undergo preconditioning 208 prior to being communicated into the cyclonic nucleation chamber for cyclonic nucleation 202. Preconditioning 208 can include cooling the humid gas 201 to a temperature of between about 33° F. and about 75° F. Preconditioning 208 can include mixing or agitating the humid gas 201 to introduce turbulence, such as by passing the humid gas 201 through a static mixer, passing the humid gas 201 about fixed or moving baffles, or otherwise causing fluidic agitation of the humid gas 201 prior to communicating the humid gas 201 into the cyclonic nucleation chamber for cyclonic nucleation 202. In some embodiments, a portion of the nucleation initiator 203 can be combed with the humid gas 201 during preconditioning 208 and before communicating the humid gas 201 into the cyclonic nucleation chamber for cyclonic nucleation 202, while a remainder of the nucleation initiator 203 is dispersed within the humid gas 201 after communicating the humid gas 201 into the cyclonic nucleation chamber for cyclonic nucleation 202.

In some embodiments the humid gas 201 may be from an industrial process that produces steam and rejects it to the environment. This steam may be cooled in the preconditioning 208 to increase the supersaturation of the steam prior to being communicated to the cyclonic nucleation chamber for cyclonic nucleation 202.

In some embodiments, the concentrate may have a sufficiently high concentration of the nucleation initiator 203 such that the concentrate can be returned directly as retentate return 209 for use as the nucleation initiator 203 for cyclonic nucleation 202 of a subsequent volume of humid gas 201. In some embodiments, the concentrate may have a concentration of the nucleation initiator 203 that is not sufficiently high for the concentrate to be returned directly for use as the nucleation initiator 203 for cyclonic nucleation 202 of a subsequent volume of the humid gas 201. In either or both cases, it may be helpful or necessary to make up some percentage of loss of the nucleation initiator 203 at a reservoir of the same by adding make-up nucleation initiator 210 to the retentate return 209 to achieve a suitable volume and/or composition of nucleation initiator 203 for use in cyclonic nucleation 202 of a subsequent volume of humid gas 201. In some embodiments, the make-up nucleation initiator 210 can have a same or different composition as that of the retentate return 209. In some embodiments, such as when the retentate return 209 comprises an insufficiently low concentration of the nucleation initiator 203, the make-up nucleation initiator 210 can have a relatively higher concentration of the nucleation initiator 203 such that the combination of the retentate return 209 and the make-up nucleation initiator 210 properly forms the nucleation initiator 203. In other embodiments, a ratio of the retentate return 209 to the make-up nucleation initiator 210 that are mixed/combined to form a subsequent volume of the nucleation initiator 203 can be varied based on different/changing concentrations of the nucleation initiator 203 in the retentate return 209 and either a static or dynamic concentration of the nucleation initiator 203 in the make-up nucleation initiator 210.

While not illustrated, if the retentate return 209 has undesirable characteristic(s) such as an undesirably high temperature which would inhibit or retard cyclonic nucleation 202 of the subsequent volume of humid gas 201, the corresponding characteristic(s) of the make-up nucleation initiator 210 can be adjusted such that the combination of the retentate return 209 and the make-up nucleation initiator 210 properly forms a nucleation initiator 203 that has the appropriate characteristic(s).

While not illustrated, if the retentate return 209 includes undesirable materials that would inhibit or retard cyclonic nucleation 202 of the subsequent volume of humid gas 201, or would contaminate the product water 207 for example, the AWG process 200 can include a further filtration or separation process to remove the undesirable materials from the retentate return 209 before a volume of the retentate return 209 is combined with a volume of the make-up nucleation initiator 210 to form the nucleation initiator 203.

The AWG process 200 can, optionally, further include steps for processing the dry gas 205, such as for increasing or reducing the temperature of the dry gas 205, removing impurities such as particulates, conducting chemical exchanges, or removing undesirable components or compounds. For example, the AWG process 200 can, optionally, further include carbon capture 211 in which carbon-containing molecules and compounds are removed from the dry gas 205. Carbon capture 211 can comprise (i) storage of removed carbon-containing molecules and compounds, such as in a tank, under the ground, (ii) destruction of carbon-containing molecules and compounds, such as thermal destruction to convert heavier or more complex carbon-containing molecules and compounds to lighter and less complex carbon-containing molecules and compounds, and/or (iii) conversion of carbon-containing molecules to other materials, such as fuels, polymers, chemicals, resins, and/or the like.

In certain embodiments, the AWG system used to carry out the AWG process 200 may be integrated with one or more carbon dioxide filtration/capture modules, one or more greenhouse modules, one or more power generation modules, and/or the like. For example, the source air intake into the AWG system may be routed through a carbon dioxide capture system (after extracting water vapor out of the atmospheric air) prior to exhausting the dry, dehumidified air to the surrounding environment. The captured carbon dioxide may be stored for later processing in a tank, or it may be released (e.g., in a monitored quantity) into one or more greenhouse modules to increase the carbon dioxide concentration within the greenhouse to thereby increase crop growth efficiency.

Moreover, a power generation module, which may comprise one or more renewable energy power generation systems, such as solar/photovoltaic, geothermal, and/or the like, or hydrocarbon-fuel based power generation systems, may be integrated with the AWG system used to carry out the AWG process 200 to provide needed electrical and/or thermal energy inputs for the AWG process 200. In the event that such power generation modules generate carbon dioxide or other exhaust gases, the exhaust gases of the power generation modules may be routed through the carbon dioxide capture modules to decrease the carbon dioxide production of the integrated system.

An AWG system, such as that used to carry out the AWG process 200, can utilize an absorption system for extracting water from atmospheric air or other gaseous fluid flows capable of supporting or carrying water vapor or otherwise having a non-zero humidity. Even for low-humidity atmospheric air (air having a humidity of greater than zero), certain amounts of water can be extracted from the air, at least in part by contacting the atmospheric air with a rich desiccant solution under controlled conditions conductive to mass transfer of water from the atmospheric air (where it exists in vapor form) into a dilutant of the desiccant solution (where it exists in liquid form). The controlled conditions may define particular temperature and/or pressure conditions, so as to raise the vapor pressure existing within the controlled environment. Aspects of controlling the environment to encourage condensation of water vapor from atmospheric air into a desiccant solution include controlling the temperature (e.g., lower the temperature of atmospheric air as it contacts the desiccant solution), controlling the pressure (e.g., increasing the pressure of the air as it contacts the desiccant solution), controlling the surface area of desiccant solution as it contacts the atmospheric air (e.g., flowing the desiccant solution across various high-surface area plates to increase the surface area of the desiccant solution), and/or controlling the flowrate and/or flow path of the atmospheric air and/or the desiccant solution (e.g., providing a turbulent flow of the atmospheric air as it contacts the desiccant solution). Certain embodiments incorporate air compression mechanisms, air cooling mechanisms, or air humidity increasing mechanisms to optimize the amount of water extracted from air (per unit of source air intake into the AWG system).

While the present description includes various embodiments of cyclonic nucleation chambers and cyclonic nucleation tanks, or the like, wherein cyclonic nucleation (e.g., 102, 202) of water molecules from water vapor in a humid gas (e.g., 101, 201) can be carried out, other embodiments, designs, configurations, and processes are contemplated and will readily come to mind, based on the present disclosure, for a person of skill in the relevant art. Several non-limiting example processes and cyclonic nucleation chambers/tanks are hereafter described, which represent only a portion of the example processes and cyclonic nucleation chambers/tanks contemplated.

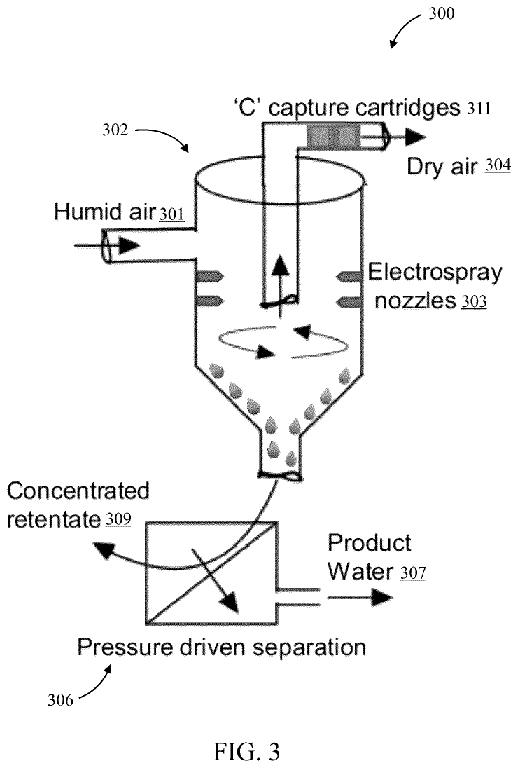

Referring now to FIG. 3, an example process 300 is illustrated in which a particular example design and configuration for a cyclonic nucleation chamber 302 is used. The cyclonic nucleation chamber 302 illustrated in FIG. 3 is partially columnar in shape at a top portion of the cyclonic nucleation chamber 302 and partially conical in shape at a bottom portion of the cyclonic nucleation chamber 302. As illustrated, humid air 301 is introduced into the top portion of the cyclonic nucleation chamber 302 and follows along a cyclonic pathway defined therein.

One or more electrospray nozzles 303 are configured to electrically charge and disperse charged droplets of a nucleation initiator into the cyclonic nucleation chamber 302 at another point within the top portion of the cyclonic nucleation chamber 302. The dispersion of charged droplets of the nucleation initiator into the cyclonic nucleation chamber 302 while the humid air 301 is traveling along the cyclonic pathway defined therein causes at least partial nucleation of water droplets from water vapor in the humid air 301 about some or all of the charged droplets of the nucleation initiator. The water droplets that nucleate about charged droplets of water vapor from the humid air 301, can absorb other water droplets as they form until the water droplets have too large a mass to be sustained within the humid air 301, leading to condensation of the water droplets in the bottom portion of the cyclonic nucleation chamber 302.

The bottom portion of the cyclonic nucleation chamber 302 can be dimensioned and configured such that the condensed water droplets collect on an inner surface, a condensation substrate, or the like. The condensed water droplets can collect via gravity in the bottom portion of the cyclonic nucleation chamber 302 and be communicated out of the cyclonic nucleation chamber 302 as an aqueous solution of the water droplets and nucleation initiator.

The nucleation of water droplets from water vapor in the humid air 301 forms dry air 304 that can be communicated out of the cyclonic nucleation chamber 302, e.g., out of the top portion of the cyclonic nucleation chamber 302. The aqueous solution of water droplets and nucleation initiator can be communicated to a device or system for pressure driven separation 306. Pressure driven separation 306 produces product water 307 and a concentrated retentate 309 that includes nucleation initiator.

The dry air 304 can be communicated out of a top portion of the cyclonic nucleation chamber 302 and further processed to remove/extract carbon-containing molecules or compounds. For example, carbon capture cartridges 311 can be used to capture carbon-containing molecules or compounds. Separation of the carbon-containing molecules or compounds from the dry air 304 can be carried out using any suitable solvent, sorbent, rare earth material, exchange bed, catalyzed conversion/exchange process, calcium hydroxide, lithium hydroxide, molecular consumption, a temperature swing absorption (TSA) process, amine absorption, cryogenic separation, membrane filtration, metal-organic framework (MOF) absorption, variations thereof, combinations thereof, and/or any other suitable approach or process.

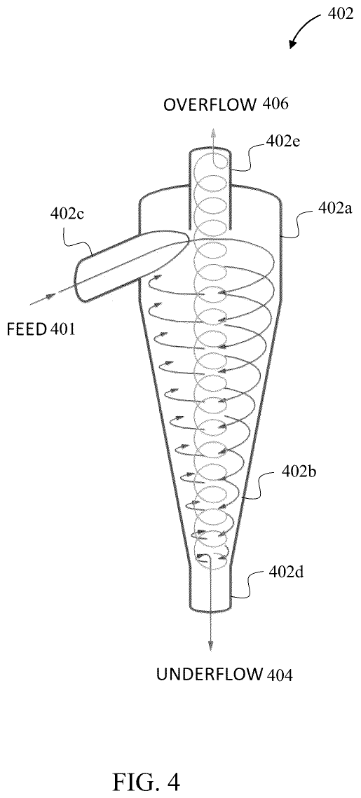

Referring now to FIG. 4, another example of a cyclonic nucleation chamber 402 is illustrated, according to an embodiment. The cyclonic nucleation chamber 402 illustrated in FIG. 4 is partially columnar in shape at a top portion 402a of the cyclonic nucleation chamber 402 and partially conical in shape at a bottom portion 402b of the cyclonic nucleation chamber 402. As illustrated, a humid air feed 401 is introduced via an inlet port 402c into the top portion 402a of the cyclonic nucleation chamber 402 and follows along a cyclonic pathway defined therein.

While not illustrated in FIG. 4, charged droplets of a nucleation initiator can be dispersed into the top portion 402a of the cyclonic nucleation chamber 402. The dispersion of charged droplets of the nucleation initiator into the cyclonic nucleation chamber 402 while the humid air feed 401 is traveling along the cyclonic pathway defined therein causes at least partial nucleation of water droplets from water vapor in the humid air feed 401 about some or all of the charged droplets of the nucleation initiator. The water droplets that nucleate about charged droplets of water vapor from the humid air feed 401, can absorb other water droplets as they form until the water droplets have too large a mass to be sustained within the humid air feed 401, leading to condensation of the water droplets in the bottom portion 402b of the cyclonic nucleation chamber 402.

The bottom portion 402b of the cyclonic nucleation chamber 402 can be dimensioned and configured such that the condensed water droplets collect on an inner surface, a condensation substrate, or the like. The condensed water droplets can collect via gravity in the bottom portion 402b of the cyclonic nucleation chamber 402 and be communicated, via an outlet port 402d of the cyclonic nucleation chamber 402, out of the cyclonic nucleation chamber 402 as an underflow 404 of the aqueous solution of the water droplets and nucleation initiator.

The nucleation of water droplets from water vapor in the humid air feed 401 forms dry air that can be communicated, via an exhaust port 402e of the cyclonic nucleation chamber 402, as overflow 406 of the dry air out of the cyclonic nucleation chamber 402. The exhaust port 402e can be positioned or located in the top portion 402a of the cyclonic nucleation chamber 402. The aqueous solution of water droplets and nucleation initiator can be communicated to a device or system for pressure driven separation to produce product water and a concentrated retentate that includes nucleation initiator.

A relative difference between a diameter of the top portion 402a and the diameter of the bottom portion 402b of the cyclonic nucleation chamber 402 can vary, such as between the shape, size, and form factor of the cyclonic nucleation chamber 402 illustrated in FIG. 4 and that of the cyclonic nucleation chamber 302 illustrated in FIG. 3. This difference can lead to a change in the slope of one or more internal surfaces of the cyclonic nucleation chamber 402. In some embodiments, there may be no or very little change in slope of the internal surface vertically across the top portion 402a of the cyclonic nucleation chamber 402. In some embodiments, there may be, relative to the change in slope of the internal surface vertically across the top portion 402a, a larger change in slope of the internal surface vertically across the bottom portion 402b of the cyclonic nucleation chamber 402. In some embodiments, the slope of the top portion 402a and/or the bottom portion 402b of the cyclonic nucleation chamber 402 can depend at least in part on a diameter of the outlet port 402d relative to a diameter of the top portion 402a of the cyclonic nucleation chamber 402.

Absent other changes, a steeper slope of the bottom portion 402b of the cyclonic nucleation chamber 402 will reduce the total surface area of the internal surface in the bottom portion 402b of the cyclonic nucleation chamber 402, which may lead to reduced condensation of water droplets thereon. However, a steeper slope of the bottom portion 402b of the cyclonic nucleation chamber 402 will result in a reduced volume of the bottom portion 402 of the cyclonic nucleation chamber 402. As water droplets are condensed out of the humid air feed 401 and relatively drier air is formed in the cyclonic nucleation chamber 402, the heat of condensation may heat the relatively dryer air, which in a smaller volume, causes the relatively dryer air to rise more quickly from the bottom portion 402b to the top portion 402a of the cyclonic nucleation chamber 402, and escape as overflow 406 dry air through the exhaust port 402e of the cyclonic nucleation chamber 402.

Conversely, a cyclonic nucleation chamber 402 that has a less steep bottom portion 402b, absent other changes such as increased height of the cyclonic nucleation chamber 402 or increased height of the bottom portion 402b relative to the top portion 402a, will lead to a relative increase in surface area for aiding condensation of water droplets from water vapor in the humid air feed 401, and increased volume of the bottom portion 402b, leading to a relatively reduced speed at which the relatively dryer air rises from the bottom portion 402b to the top portion 402a of the cyclonic nucleation chamber 402.

There are other reasons and considerations for why a cyclonic nucleation chamber 402 may be dimensioned differently or have an alternative form factor. For example, a particular AWG system may require a smaller spatial footprint or allow for a larger spatial footprint for the cyclonic nucleation chamber 402. Additionally or alternatively, if a heaver nucleation initiator is used, a relatively larger surface area for condensation and collection of the aqueous solution of water droplets from water vapor and the nucleation initiator in the bottom portion 402b of the cyclonic nucleation chamber 402 may not be necessary and/or helpful. Also, depending on an air speed of the humid air feed 401 along the cyclonic pathway within the cyclonic nucleation chamber 402, condensation may be aided by residence time across an internal surface of the bottom portion 402b of the cyclonic nucleation chamber 402 more so than by increasing the available surface area for condensation therein.

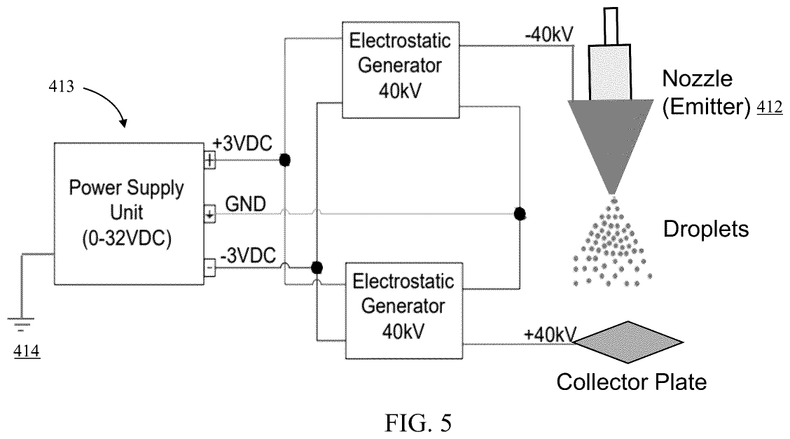

Referring now to FIG. 5, an example nozzle 412 is illustrated, according to an embodiment. The nozzle 412 is configured to receive a flow of a liquid nucleation initiator, or a solution comprising the nucleation initiator, such as from a reservoir containing a reserve of the nucleation initiator or the solution comprising the nucleation initiator. The nozzle 412 includes an inlet or conduit that defines a lumen therethrough that is connected to an outlet of the nozzle 412. The nozzle 412 includes a tapering portion that constricts the flow of the liquid nucleation initiator. The nozzle 412 can be configured to form discrete droplets of the liquid nucleation initiator.

The nozzle 412 can comprise one or more electrodes (not shown) that are located about or within the nozzle 412, e.g., the tapered portion of the nozzle 412. The one or more electrodes are in electrical communication with a computing device 413 that is configured to control a voltage of electrical current supplied to the one or more electrodes based on a resulting charge of the droplets of the liquid nucleation initiator being dispersed from the outlet of the nozzle 412. For example, the benchtop power supply unit (0-32 VDC), as depicted herein FIG. 5 is being connected to at least one electrostatic generator unit (40 kV) in series or parallel configuration before integrating them to the spray nozzles. The power supply unit and the electrostatic generators are electrically grounded and properly insulated to minimize the arcing. The computing device 413 can be in further electrical communication with an electrical source 414 configured to supply electrical energy to the computing device 413. In such an embodiment, the droplets of the liquid nucleation initiator are electrically charged as they are formed at the nozzle 412 but before the droplets of the liquid nucleation initiator are dispersed from the outlet of the nozzle 412.

Additionally or alternatively, the nozzle 412 can include no electrodes about or within the nozzle 412—instead, one or more electrodes can be disposed within the inner volume of the cyclonic nucleation chamber 402 at or about a dispersal location for the droplets of the liquid nucleation initiator being dispersed from the outlet of the nozzle 412. In such an embodiment, the droplets are formed at the nozzle 412, then dispersed from the outlet of the nozzle 412, and subsequently the droplets of the liquid nucleation initiator are electrically charged before they disperse within the inner volume of the cyclonic nucleation chamber 402.

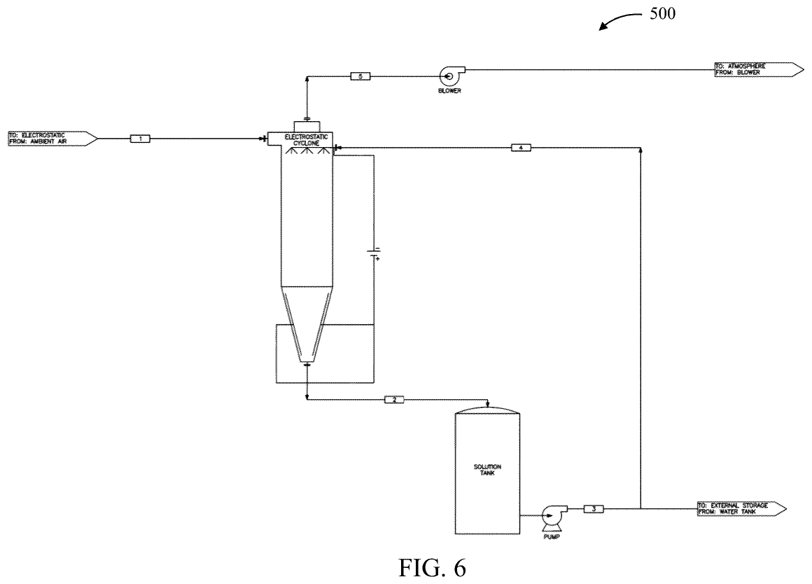

Referring now to FIG. 6, an example AWG process 500 is illustrated for an atmospheric water generator using an integration of electrostatic force field on charged water droplets. The AWG process 500 begins when humid air or another humid gas flow (i.e., a flow of a gaseous fluid having a humidity greater than 0% humidity) is introduced into an electrostatic cyclone chamber or cyclonic nucleation chamber under turbulent conditions. As used herein, the terms ‘electrostatic cyclone chamber’ and ‘cyclonic nucleation chamber’ both refer to a vessel configured to receive a humid gas, direct the humid gas along a cyclonic pathway within the vessel, use a nucleation initiator to initiate nucleation of water droplets from water vapor in the humid gas, and condense the water droplets out of the humid gas to at least partially dehumidify the humid gas and produce a condensate fluid comprising liquid water. The terms ‘electrostatic cyclone chamber’ and ‘cyclonic nucleation chamber’ may be used to refer to the same or different embodiments of the systems, processes, devices, vessels, and/or methods disclosed herein. One or more electrostatic sprayers are disposed within the electrostatic cyclone chamber and configured to disperse electrically charged droplets of a nucleation initiator. In some embodiments, the nucleation initiator comprises water droplets. In certain embodiments, turbulent gas flow conditions may be accomplished in the electrostatic cyclone chamber by, e.g., rigorous mixing, spinning, stirring, or rotation. In some embodiments, the one or more electrostatic sprayers can comprise a nozzle and an electrode connected to a negative direct current (DC) power supply with voltage ranging from 0 kV to about 100 kV. The negative electrode is configured to convey a charge to the nucleation initiator, e.g., droplets of the nucleation initiator, before, at, or after the nozzle. A positive electrode may be used in the body of the electrostatic cyclone chamber as a collection area for electrostatically charged water droplets.

The humid gas being introduced in a turbulent manner into the electrostatic cyclone chamber comprises water vapor molecules. Without wishing to be bound by any particular theory, the water vapor molecules with predefined dipole momentum in the humid gas may be attracted by at least one of the electrostatically charged water droplets due to dielectrophoresis forces caused by a gradient electric field.

In certain embodiments, to increase the flow rate of incoming humid gas, blowers may be used upstream and/or a vacuum can be used downstream.

In some embodiments, the nucleation initiator may comprise water droplets. In some embodiments, the water droplets can be initially charged to a predetermined charge or to a charge at a predefined threshold, before dispersing the water droplets into the electrostatic cyclone chamber. A predefined threshold may include, e.g., a threshold Reyleigh limit. Without wishing to be bound by any particular theory, when the vapor density exceeds the saturation level, electrospray water droplets which were initially charged to their threshold Rayleigh limit, may behave as nucleation centers, leading to electrostatic force-induced nucleation at equilibrium conditions. When behaving as nucleation centers, the pre-charged water droplets may enable further growth of water droplets through further deposition/nucleation of water vapor from the humid input gas, until the water droplets reach a saturation limits of droplet size, as dictated by water vapor pressure at or near the droplet surface during nucleation.

Once water droplets, which started out as charged water droplets but accumulated in size through deposition/nucleation of water vapor from the humid input gas, reach a certain mass and/or volume, the outgrown large water droplets can be condensed. In some embodiments, depending on the electrostatic cyclone chamber design and other factors of cyclonic nucleation, condensation of such large water droplets can be at least partially caused by centripetal force(s), which may be attributed to vertical airflow within the chamber. Other contributing causes may include an effective shearing force on water droplets caused by surface characteristics of the internal wall of the electrostatic cyclone chamber, thermodynamic factors such as the difference between water droplet temperature and internal surface temperature in the electrostatic cyclone chamber, and/or other factors or characteristics.

Without wishing to be bound by any particular theory, a rate of condensation may depend on both the electrical conductivity of the charged water droplets and also on the size and polydispersity of the charged water droplets. In some embodiments, enhanced water vapor capture can be achieved by introducing hygroscopic salts (e.g., very low concentrations of hygroscopic salts) such as NaCl or others, which can later be recovered using a separation technique (e.g., a membrane-based separation technique). In some embodiments, tiny hygroscopic salt particles in a turbulent, humid airflow can become nuclei for condensation of water vapor under favorable conditions. While the initial droplet size may depend primarily on flow rate, the presence of NaCl may enhance the solution conductivity, leading to the production of droplets with more controlled size and polydispersity.

In some embodiments, rather than electrostatically charged water droplets being used as the nucleation initiator, a liquid desiccant can be used. In the electrostatic cyclone chamber, the input humid gas may be exposed to a charged liquid desiccant droplet. Without wishing to be bound by any particular theory, when exposing input humid gas to charged liquid desiccant droplets, the electrical charge in the liquid droplet may increase the tendency of the water vapor molecules (in the input humid gas) with predefined dipole momentum to deposit themselves on the charged droplet of liquid desiccant droplets. This deposition, or nucleation, of water vapor molecules on charged desiccant droplets, may result in the partial dehumidification of the humid input gas entering the electrostatic cyclone chamber at given conditions.

AWG processes and systems may not include any further separation process or devices, in certain embodiments. However, in the AWG process 500 embodied in FIG. 6, the condensed water is collected at the bottom outlet of the electrostatic cyclone chamber as product water, and stored in a product water tank. A portion of the extracted water is recirculated back to the electrospray nozzles as liquid nucleation initiator (e.g., for making charged water droplets), whereas the captured dry gas is allowed to pass through carbon ‘C’ capture cartridges prior to exhausting the dry, dehumidified gas to the surrounding environment, thereby reducing the carbon footprint of the AWG process 500 and contributing to a more circular economy. In certain embodiments, mist eliminators are integrated within or at the entry of the dry gas outlet stream to avoid or minimize the media carryover, resulting in collecting dry gas. Mist eliminators may include, fine metallic or non-metallic mesh with consistent pore size, allowing the dry gas to pass through the carbon capture cartridges but restricting the media carryover.

In certain embodiments, the AWG process 500 can use an electrostatic cyclone chamber having different shapes of condensation surfaces, including, but not limited to, a spiral coil/wire and/or a flat plate for improved condensation rate. In some embodiments, additional cooling (e.g., within the condensation surfaces) can be implemented in the AWG process 500 to help improve system efficiency and aid in condensation. In certain embodiments, the AWG process 500 can use an electrostatic cyclone chamber that utilizes a vertical flow to separate the largest droplets from the gas and collect them on a sidewall. Without wishing to be bound by any particular theory, when the charged droplets collide with each other, it may cause or facilitate water vapor condensation and reduce the initial charge. This may reduce or eliminate the need for high-magnitude external electrostatic fields and cold surfaces to remove water droplets from the gas stream when the gas moves quickly.

In an embodiment, an example electrostatic nucleation system may comprise carbon capture cartridge(s) or carbon extraction process(es) downstream of the AWG process 500 (e.g., along an gas flow path between an gas intake and an gas exhaust) before the capture of dry gas. In some embodiments, captured carbon dioxide may be directed to a greenhouse and/or a storage tank. In certain embodiments, the greenhouse may be supplied by water produced during the AWG process 500, such as those discussed herein for improved crop growth. In certain embodiments, the AWG system may integrate the AWG process 500 with one or more power generation modules, one or more bottled water plants, and/or the like.

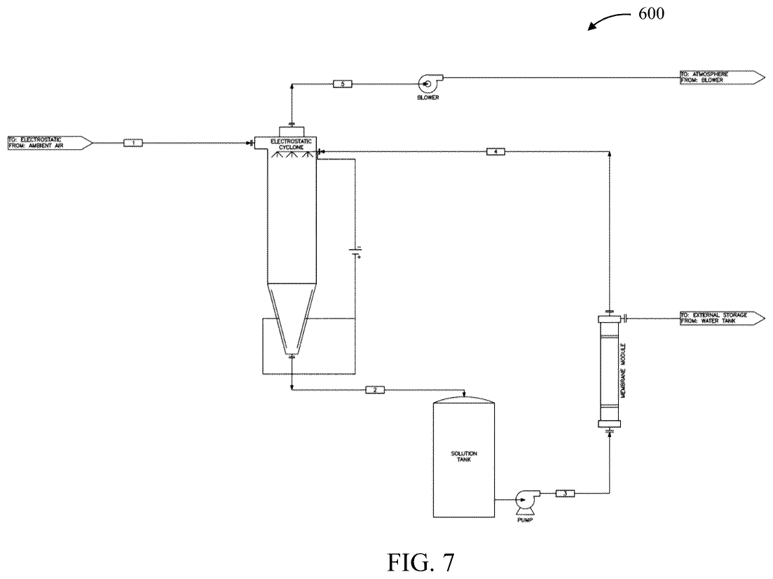

FIG. 7 illustrates an example flow diagram of an AWG process 600. In some embodiments, the AWG process 600 may include various elements or steps that are similar or substantially the same as those described above regarding the AWG process 500.

The AWG process 600 can include communicating an input humid gas into an electrostatic cyclone chamber under turbulent conditions. A nucleation initiator is communicated to one or more electrospray nozzles that are configured to form droplets of the nucleation initiator and apply a negative charge to the nucleation initiator droplets before dispersing the charged nucleation initiator droplets into the electrostatic cyclone chamber. The charged nucleation initiator droplets act as nucleation centers and cause deposition of water vapor molecules to the charged nucleation initiator droplets through charge attraction. The charged nucleation initiator droplets grow in mass and volume as the water vapor nucleates about the charged nucleation initiator droplets, which diminishes the charge of the nucleation initiator droplets. The nucleation initiator droplets are preferentially condensed on surface(s) within the electrostatic cyclone chamber while the carrying gas continues moving at a relatively high air speed and without requiring that the surface(s) within the electrostatic cyclone chamber be substantially cooled to aid in condensation.

In some embodiments, the AWG process 600 is carried out in a system that further comprises a solution tank in which captured water and hygroscopic media is stored upstream of a membrane filtration module that is used to recover the salt from extracted water. In certain embodiments, the electrostatic nucleation configurations discussed herein may be utilized together with one or more membrane separation systems to separate pure water from hygroscopic media, such as a membrane-based separation system discussed in co-pending U.S. patent application Ser. No. 17/690,550, filed Mar. 9, 2022, the entire contents of which are hereby incorporated herein by reference in their entirety for all purposes.

In some embodiments, the AWG process 600 can be carried out in an AWG system that uses thermal purification techniques after water exits the electrostatic cyclone chamber. These separation techniques include, but are not limited to, distillation, membrane distillation, or a combination thereof. In certain embodiments, the AWG process 600 can comprise a pressure separation/filtration process downstream of the electrostatic cyclone chamber. The pressure separation/filtration process may include but is not limited to reverse osmosis, forward osmosis, ultra and/or nanofiltration, membrane extraction, or a combination thereof. In certain embodiments, other separation techniques may be used additionally or alternative, such as electrodialysis, liquid-liquid extraction, absorption/desorption, and/or a combination thereof.

As discussed herein, the AWG process 600 comprises a water nucleation approach that leads to improved process efficiency, even under unfavorable conditions associated with many AWG processes and AWG process implementations. In embodiments where hygroscopic media may be used in the system to increase the separation of water from the gas in the electrostatic cyclone chamber, at least one water vapor molecule is attracted by at least one charged aqueous hygroscopic droplet injected by the electrospray nozzles. In some embodiments, the hygroscopic media may comprise CaCl₂, NaCl, LiCl, MgCl₂, KCOOH, CH₃COOK, ionic liquids, or a combination thereof. In certain embodiments, the hygroscopic media may comprise other materials including, but not limited to, colloids, nanomaterials, and/or a combination thereof for enhancing process efficiency. In some embodiments, a fraction of the water collected during condensation may be combined with or without recovered hygroscopic media and can be recycled to the electrospray nozzles. The portion of water not returned to the electrospray nozzles may be stored as product water.

In some embodiments, humid gas may be purified prior to being communicated into the electrostatic cyclone chamber. This can be done by, e.g., passing the humid gas through one or more filter media, exchange beds, electrostatic precipitators, and/or the like, prior to introducing the humid gas to the electrostatic cyclone chamber. Purifying the humid gas prior to communicating the humid gas into the electrostatic cyclone chamber reduces any pollutants in the gas prior to the gas entering the system. Media filters may induce a charge on the humid gas to help collect large dust particles in the gas, similar to electrostatic precipitation.

In some embodiments, humid gas may be communicated into the electrostatic cyclone chamber as induced or forced gas, such as by using gas intake systems from another process such as one or more gas conditioning systems located upstream of the gas intake flow path of the AWG process 600. In certain forced gas embodiments, the electrostatic cyclone chamber may be located downstream of an existing process that sends all or a portion of its exhaust gas, process gas, waste gas, humid gas, or other such gas stream, into the electrostatic cyclone chamber for the separation of water from the humid gas. This configuration may supply all the gas needed for operating the electrostatic cyclone chamber at a safe/normal operating capacity or may supply only a portion of the gas needed for operating the electrostatic cyclone chamber at a safe/normal operating capacity. A makeup blower may be provided to supplement the gas intake to ensure enough gas is provided to the electrostatic cyclone chamber if the upstream process does not provide enough humid gas needed for operating the electrostatic cyclone chamber at a safe/normal operating capacity.

In certain induced gas/air embodiments, the electrostatic cyclone chamber may be located upstream of another process that utilizes air, and the downstream system may pull dry air from the electrostatic cyclone chamber upstream of it, which can then set a dry air demand rate for the downstream system, which may dictate or at least be considered when setting an operating level (e.g., humid air intake rate) of the electrostatic cyclone chamber and/or other devices/systems during the AWG process 600. Makeup blowers may be used to assist the downstream process in pulling the dry air from the cyclone and/or to assist the AWG process 600 in being supplied by sufficient humid air to accommodate the dry air demand by the downstream process. In certain instances, the downstream process may utilize a venturi cylinder or another device that uses the venturi affect to create a low pressure/partial vacuum in or after the electrostatic cyclone chamber, thereby inducing the flow of humid air into the electrostatic cyclone chamber.

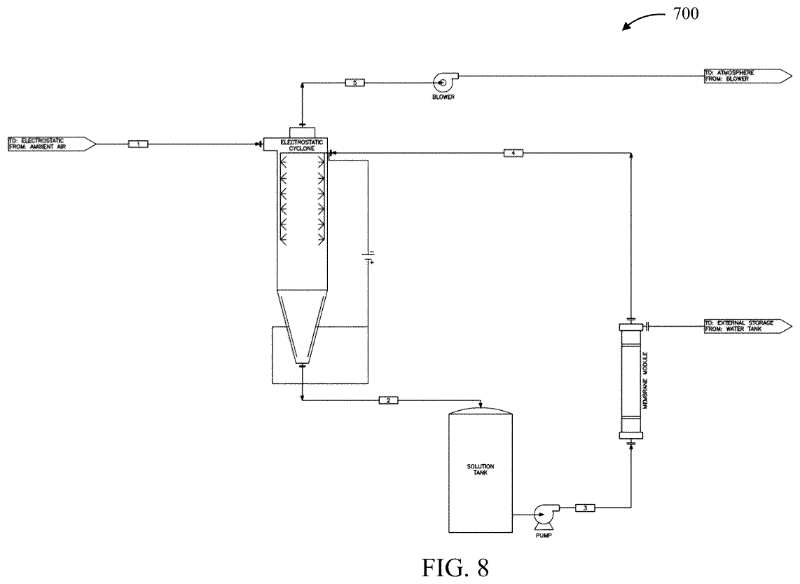

Referring now to FIG. 8, an example AWG process 700 is illustrated, according to an embodiment. In some embodiments, the AWG process 700 may include various elements or steps that are similar or substantially the same as those described above regarding the AWG process 500, or the AWG process 600.

The AWG process 700 can include communicating an input humid air into an electrostatic cyclone chamber under turbulent conditions. A nucleation initiator is communicated to one or more electrospray nozzles that are configured to form droplets of the nucleation initiator and apply a negative charge to the nucleation initiator droplets before dispersing the charged nucleation initiator droplets into the electrostatic cyclone chamber. The charged nucleation initiator droplets act as nucleation centers and cause deposition of water vapor molecules to the charged nucleation initiator droplets through charge attraction. The charged nucleation initiator droplets grow in mass and volume as the water vapor nucleates about the charged nucleation initiator droplets, which diminishes the charge of the nucleation initiator droplets. The nucleation initiator droplets are preferentially condensed on surface(s) within the electrostatic cyclone chamber while the carrying air continues moving at a relatively high air speed and without requiring that the surface(s) within the electrostatic cyclone chamber be substantially cooled to aid in condensation.

In some embodiments, the AWG process 700 is carried out in a system that comprises an electrostatic cyclone chamber operatively connected to a humid air inlet, at least one electrospray nozzle, a product water outlet, and/or a combination of carbon capture cartridges and/or a separation system. In certain embodiments, the AWG process 700 may be carried out using electrostatic cyclone chambers having one of a variety of different shapes, including, but not limited to cylindrical, conical, or a combination thereof. The electrostatic cyclone chamber can be operatively connected with at least one electrospray nozzle. The at least one electrospray nozzle can be protruded through at least one aperture in a shell or body of the electrostatic cyclone chamber. In some embodiments, the AWG process 700 may be carried out using a system that comprises one or more electrospray nozzles and/or multiple channels within the nozzles. The one or more electrospray nozzles can be oriented and/or tilted in different directions relative each to the others or a portion of the others. Such directional differentiation of electrospray nozzle orientation may improve the efficiency of the AWG process 700 by, e.g., further increasing the turbulence of the air flow in the electrostatic cyclone chamber, increasing the probability that each charged droplet collides with/comes into contact with a yet-to-be-nucleated water vapor molecule in the humid intake air, and/or for other reasons.

The AWG process 700 can be carried out using a system that comprises one or more electrospray nozzle(s) configured to operate with a high-voltage electrode to charge liquid droplets of the nucleation initiator. The electrostatic cyclone chamber can comprise one or more positive electrode plates and/or meshes positioned in an inner volume of the electrostatic cyclone chamber. In some embodiments, the AWG process 700 can include positively charging the positive electrode plates in the electrostatic cyclone chamber using the high-voltage electrode to cause electrically charged droplets of the nucleation initiator to collect initially at or on the positive electrode plates. In some embodiments, the distance between each of the electrospray nozzles may be varied. In some embodiments, the distance between the electrospray nozzles and the one or more positive electrode plates in the electrostatic cyclone chamber can be varied. In some embodiments, a size, shape, orientation, direction, or other characteristics of an outlet of each nozzle can be varied. In some embodiments, a number of electrospray nozzles, negative electrodes, positive electrode plates, channels within each electrospray nozzle, or other aspects can be changed or varied to achieve desired droplet dimensions, a desired droplet electrical charge, or other characteristics.

In some embodiments, the electrospray nozzles can be configured to selectively direct liquid droplets of the nucleation initiator into the inner volume of the electrostatic cyclone chamber. The electrospray nozzles can be configured to inject electrically charged liquid droplets of the nucleation initiator into the inner volume of the electrostatic cyclone chamber. When these charged droplets of the nucleation initiator mix with the incoming humid air, the charged droplets of the nucleation initiator attract water vapor molecules present in the humid air, which leads to a reduction in humidity of an air outlet stream. The nucleated water vapor forms larger and larger droplets, until it condenses inside the electrostatic cyclone chamber. The condensed water is sent to a solution tank downstream of the electrostatic cyclone chamber, followed by a membrane separation process to extract product water from the hygroscopic media.

In certain embodiments, the AWG process 700 discussed herein may be utilized together with one or more humidity-increasing systems, such as those discussed in U.S. Pat. No. 10,583,389, the entire contents of which are hereby incorporated herein by reference in their entirety for all purposes.

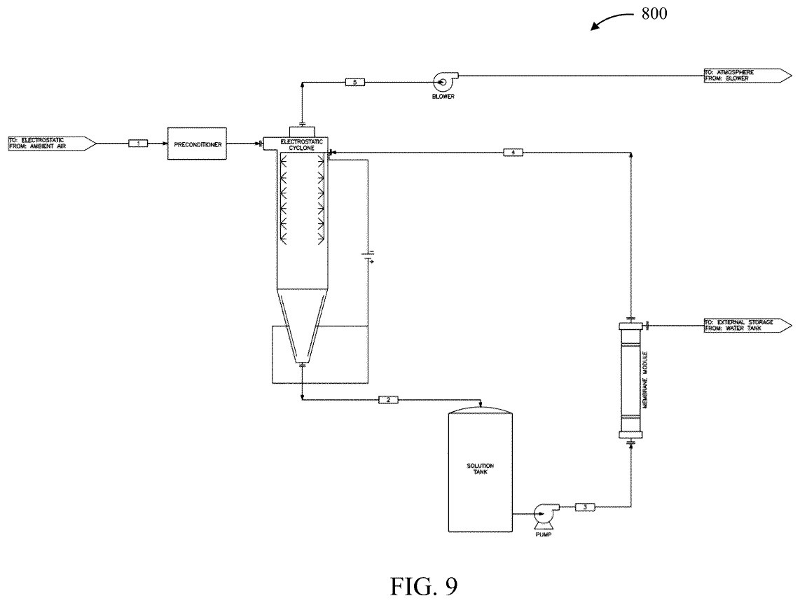

FIG. 9 illustrates another example AWG process 800. In some embodiments, the AWG process 800 may include various elements or steps that are similar or substantially the same as those described above regarding the AWG process 500, the AWG process 600, or the AWG process 700.

The AWG process 800, however, further comprises a preconditioning step prior to communication of the humid input air into the electrostatic cyclone chamber. In certain embodiments, to create a supersaturation condition (i.e., when the relative humidity of the air is greater than 95% or equal to 100%) in the electrostatic cyclone chamber, the AWG process 800 can further comprise placing a thermoelectrically cooled plate (e.g., copper plate) in the electrostatic cyclone chamber and maintaining the thermoelectrically cooled plate at a reduced temperature (e.g., −35° C., −40° C., or lower) at the bottom of the electrostatic cyclone chamber, or within the vicinity of a preconditioner. The humidity of the air within the electrostatic cyclone chamber (e.g., an intermediary air flow within a closed air circulation loop) is thereby increased, and the electrostatic nucleation-based AWG process 800 may be utilized to condense the water vapor contained within the humid air.

In certain embodiments the preconditioning step may be an industrial process in which steam is produced and rejected to the environment. In this embodiment the steam produced may be sent into the electrostatic chamber as a supersaturated steam. The steam may be cooled prior to entering the electrostatic chamber to increase the supersaturation of the steam.

As described elsewhere, one or more greenhouses may be utilized in combination with the AWG systems discussed herein and the AWG process 800, such that plants growing within the greenhouse growth habitat are watered using water generated during the AWG process 800.

The AWG process 800 comprises electrostatic nucleation of water vapor in humid air that provides high-quality water and also enables cheaper water production costs, perhaps much lower than the cost of water from desalination techniques. The AWG process 800 is characterized by a low energy requirement in all-weather conditions, unlike legacy AWG technologies that are limited by high energy requirements.

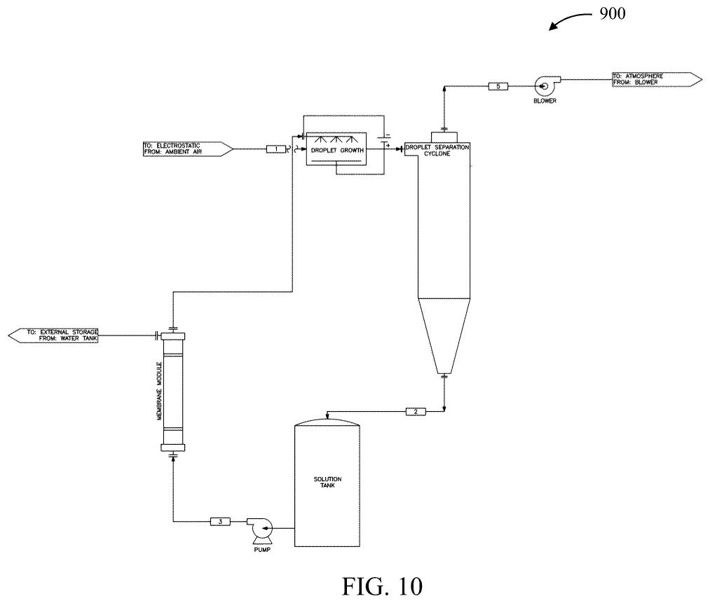

FIG. 10 illustrates another example of AWG process 900. In some embodiments the AWG process 900 may include various elements or steps that are similar or substantially the same as those described above regarding the AWG process 500, the AWG process 600, the AWG process 700, and/or the AWG process 800.

The AWG process 900, however, can alternatively comprise a split system that allows for droplet growth outside of a cyclonic nucleation chamber. In this embodiment, at least partial electrostatic nucleation may take place prior to the inlet humid gas being communicated into the cyclonic nucleation chamber. Droplets that grow prior to the inlet humid gas being communicated into the cyclonic nucleation chamber may be communicated into the cyclonic nucleation chamber, where at least some of the droplets can be separated from the inlet humid gas based on differences in density and/or particle size between the droplets and the inlet humid gas.

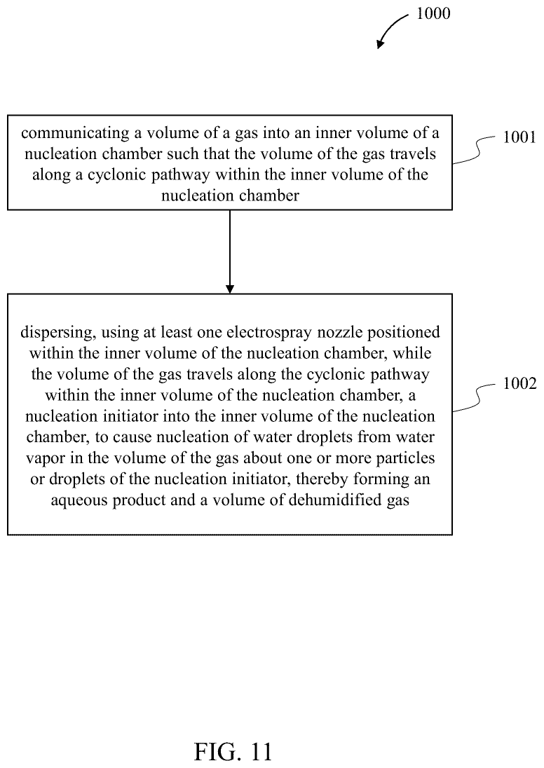

FIG. 11 is a flowchart illustrating a method 1000 that can be carried out by an AWG system or process (e.g., 100, 200, 300, 500, 600, 700, 800, and/or 900). The method 1000 comprises communicating a volume of a gas into an inner volume of a nucleation chamber such that the volume of the gas travels along a cyclonic pathway within the inner volume of the nucleation chamber, at 1001. The method 1000 further comprises dispersing, using at least one electrospray nozzle positioned within the inner volume of the nucleation chamber, while the volume of the gas travels along the cyclonic pathway within the inner volume of the nucleation chamber, a nucleation initiator into the inner volume of the nucleation chamber, to cause nucleation of water droplets from water vapor in the volume of the gas about one or more particles or droplets of the nucleation initiator, thereby forming an aqueous product and a volume of dehumidified gas, at 1002.

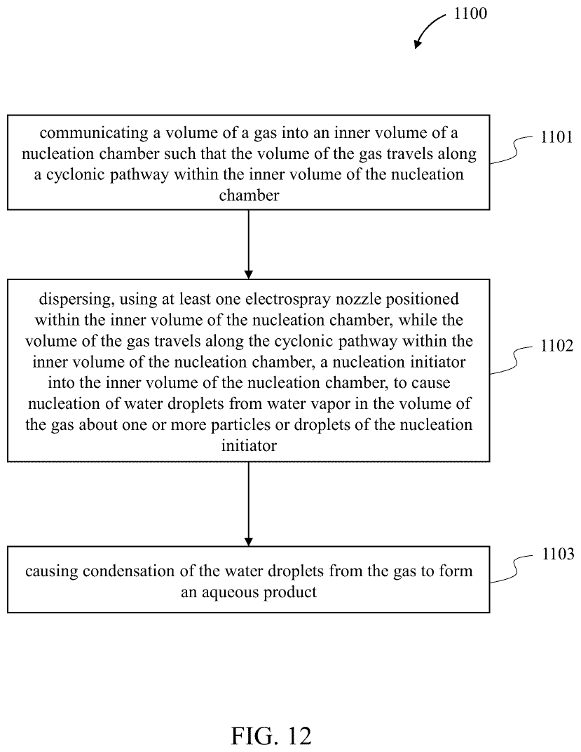

FIG. 12 is another flowchart illustrating a method 1100 that can be carried out by an AWG system or process (e.g., 100, 200, 300, 500, 600, 700, 800, and/or 900). The method 1100 comprises communicating a volume of a gas into an inner volume of a nucleation chamber such that the volume of the gas travels along a cyclonic pathway within the inner volume of the nucleation chamber, at 1101. The method 1100 further comprises dispersing, using at least one electrospray nozzle positioned within the inner volume of the nucleation chamber, while the volume of the gas travels along the cyclonic pathway within the inner volume of the nucleation chamber, a nucleation initiator into the inner volume of the nucleation chamber, to cause nucleation of water droplets from water vapor in the volume of the gas about one or more particles or droplets of the nucleation initiator, at 1102. The method 1100 further comprises causing condensation of the water droplets from the gas to form an aqueous product, at 1103.

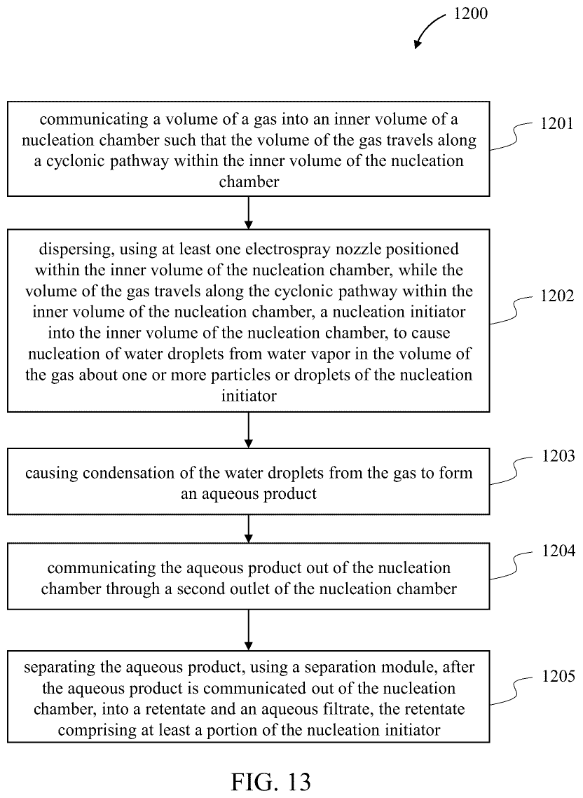

Referring now to FIG. 13, a method 1200 is illustrated that can be carried out by an AWG system or process (e.g., 100, 200, 300, 500, 600, 700, 800, and/or 900). The method 1200 comprises communicating a volume of a gas into an inner volume of a nucleation chamber such that the volume of the gas travels along a cyclonic pathway within the inner volume of the nucleation chamber, at 1201. The method 1200 further comprises dispersing, using at least one electrospray nozzle positioned within the inner volume of the nucleation chamber, while the volume of the gas travels along the cyclonic pathway within the inner volume of the nucleation chamber, a nucleation initiator into the inner volume of the nucleation chamber, to cause nucleation of water droplets from water vapor in the volume of the gas about one or more particles or droplets of the nucleation initiator, at 1202. The method 1200 further comprises causing condensation of the water droplets from the gas to form an aqueous product, at 1203. The method 1200 further comprises communicating the aqueous product out of the nucleation chamber through a second outlet of the nucleation chamber, at 1204. The method 1200 further comprises separating the aqueous product, using a separation module, after the aqueous product is communicated out of the nucleation chamber, into a retentate and an aqueous filtrate, the retentate comprising at least a portion of the nucleation initiator, at 1205.

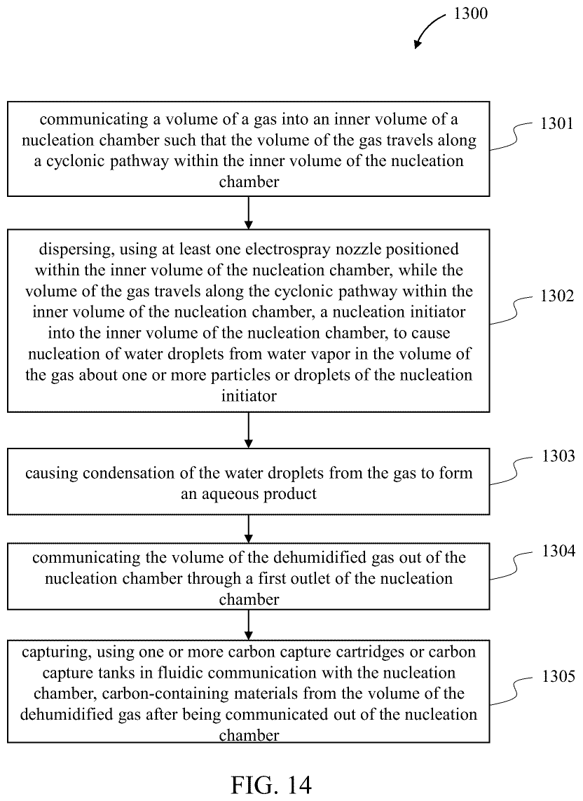

Referring now to FIG. 14, a method 1300 is illustrated that can be carried out by an AWG system or process (e.g., 100, 200, 300, 500, 600, 700, 800, and/or 900). The method 1300 comprises communicating a volume of a gas into an inner volume of a nucleation chamber such that the volume of the gas travels along a cyclonic pathway within the inner volume of the nucleation chamber, at 1301. The method 1300 further comprises dispersing, using at least one electrospray nozzle positioned within the inner volume of the nucleation chamber, while the volume of the gas travels along the cyclonic pathway within the inner volume of the nucleation chamber, a nucleation initiator into the inner volume of the nucleation chamber, to cause nucleation of water droplets from water vapor in the volume of the gas about one or more particles or droplets of the nucleation initiator, at 1302. The method 1300 further comprises causing condensation of the water droplets from the gas to form an aqueous product, at 1303. The method 1300 further comprises communicating the volume of the dehumidified gas out of the nucleation chamber through a first outlet of the nucleation chamber, at 1304. The method 1300 further comprises communicating the volume of the dehumidified gas out of the nucleation chamber through a first outlet of the nucleation chamber, at 1305.

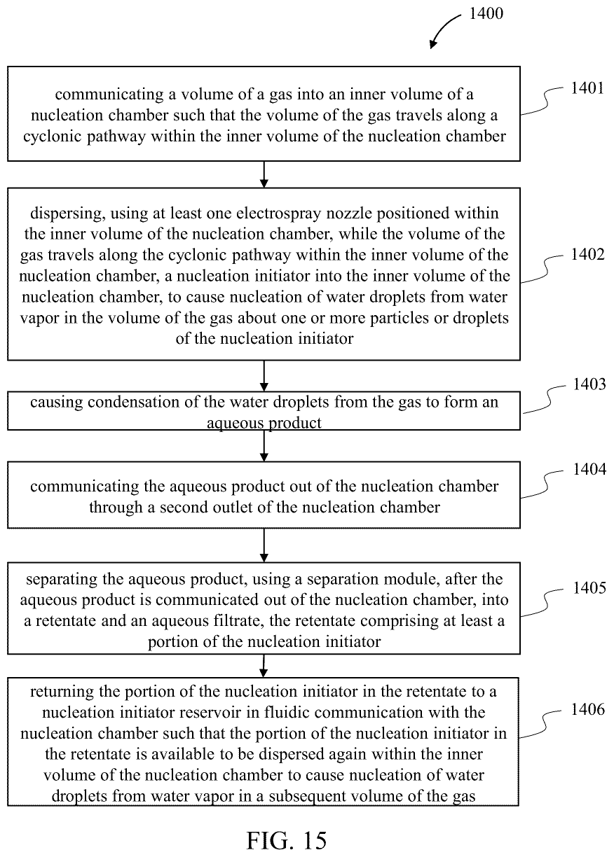

Referring now to FIG. 15, a method 1400 is illustrated that can be carried out by an AWG system or process (e.g., 100, 200, 300, 500, 600, 700, 800, and/or 900). The method 1400 comprises communicating a volume of a gas into an inner volume of a nucleation chamber such that the volume of the gas travels along a cyclonic pathway within the inner volume of the nucleation chamber, at 1401. The method 1400 further comprises dispersing, using at least one electrospray nozzle positioned within the inner volume of the nucleation chamber, while the volume of the gas travels along the cyclonic pathway within the inner volume of the nucleation chamber, a nucleation initiator into the inner volume of the nucleation chamber, to cause nucleation of water droplets from water vapor in the volume of the gas about one or more particles or droplets of the nucleation initiator, at 1402. The method 1400 further comprises causing condensation of the water droplets from the gas to form an aqueous product, at 1403. The method 1400 further comprises communicating the aqueous product out of the nucleation chamber through a second outlet of the nucleation chamber, at 1405. The method 1400 further comprises separating the aqueous product, using a separation module, after the aqueous product is communicated out of the nucleation chamber, into a retentate and an aqueous filtrate, the retentate comprising at least a portion of the nucleation initiator, at 1406. The method 1400 further comprises returning the portion of the nucleation initiator in the retentate to a nucleation initiator reservoir in fluidic communication with the nucleation chamber such that the portion of the nucleation initiator in the retentate is available to be dispersed again within the inner volume of the nucleation chamber to cause nucleation of water droplets from water vapor in a subsequent volume of the gas, at 1406.

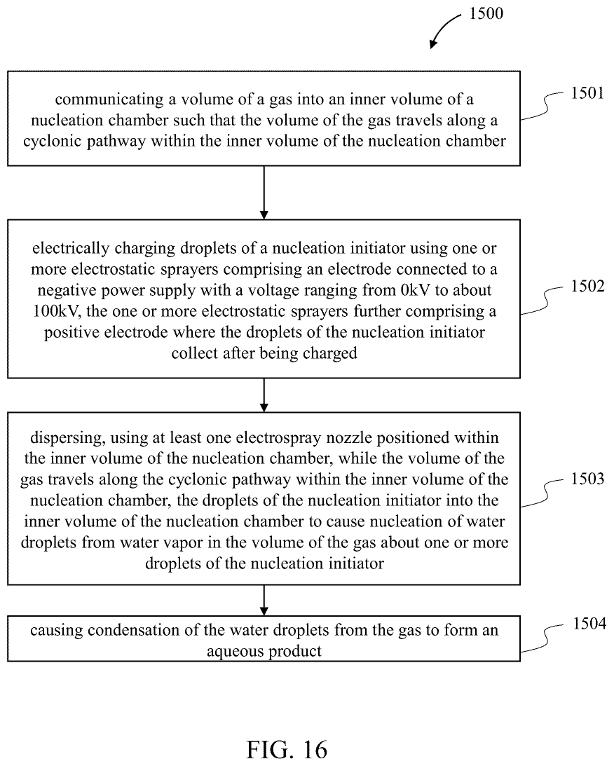

Referring now to FIG. 16, a method 1500 is illustrated that can be carried out by an AWG system or process (e.g., 100, 200, 300, 500, 600, 700, 800, and/or 900). The method 1500 comprises communicating a volume of a gas into an inner volume of a nucleation chamber such that the volume of the gas travels along a cyclonic pathway within the inner volume of the nucleation chamber, at 1501. The method 1500 further comprises electrically charging droplets of a nucleation initiator using one or more electrostatic sprayers comprising an electrode connected to a negative power supply with a voltage ranging from 0 kV to about 100 kV, the one or more electrostatic sprayers further comprising a positive electrode where the droplets of the nucleation initiator collect after being charged, at 1502. The method 1500 further comprises dispersing, using at least one electrospray nozzle positioned within the inner volume of the nucleation chamber, while the volume of the gas travels along the cyclonic pathway within the inner volume of the nucleation chamber, the droplets of the nucleation initiator into the inner volume of the nucleation chamber to cause nucleation of water droplets from water vapor in the volume of the gas about one or more droplets of the nucleation initiator, at 1503. The method 1500 further comprises causing condensation of the water droplets from the gas to form an aqueous product, at 1504.

Described herein is an atmospheric water generation (AWG) device, the AWG device comprising: a nucleation chamber having an outer shell defining an inner volume; a first inlet through the outer shell of the nucleation chamber to direct a volume of a gas into a cyclonic pathway in the inner volume of the nucleation chamber; at least one electrospray nozzle positioned within the inner volume of the nucleation chamber, wherein the at least one electrospray nozzle is configured to disperse a nucleation initiator into the inner volume of the nucleation chamber to cause nucleation of water droplets from water vapor in the volume of gas about one or more particles or droplets of the nucleation initiator to form an aqueous product; and an aqueous product outlet disposed through the outer shell of the nucleation chamber, wherein the aqueous product outlet is configured to direct at least a portion of the aqueous product out of the nucleation chamber.

In some embodiments, the AWG device can further comprise: a separation module configured to separate the aqueous product into a water-based permeate and a concentrate. In some embodiments, the separation module comprises one or more of: membrane filtration, microfiltration, nanofiltration, ultrafiltration, reverse osmosis, forward osmosis, distillation, gas separation, electrodialysis, electrode ionization, electro filtration, fuel cell, membrane distillation, evaporation, crystallization, ion exchange, electrodialysis reversal, capacitive deionization, centrifugal separation, or graphene size-exclusion membrane filtration. In some embodiments, the nucleation initiator comprises a salt, a desiccant material, a hygroscopic material, an ionic liquid, or water droplets. In some embodiments, the AWG device can further comprise: a dehumidified air outlet formed through the outer shell of the nucleation chamber, the dehumidified air outlet being configured to communicate the volume of the gas out of the nucleation chamber. In some embodiments, the AWG device can further comprise: one or more carbon capture cartridges or carbon capture tanks in fluidic communication with the dehumidified air outlet and configured to remove carbon-containing materials from the volume of the gas after being communicated out of the nucleation chamber. In some embodiments, the cyclonic pathway is defined at least in part by a concave shape of an inner surface of the nucleation chamber. In some embodiments, the shape of the inner surface of the nucleation chamber is one or more of: cylindrical, conical, spherical, columnar, pyramidal, prismatic, cubic, a torus, polyhedra, an octagonal prism, tetrahedra, octahedra, dodecahedra, icosahedra, irregularly prismatic, or irregularly pyramidal.

In some embodiments, one or more electrospray nozzles are at least partially disposed in one or more apertures extending at least partially through the outer shell of the nucleation chamber. In some embodiments, each of the one or more electrospray nozzles define a plurality of channels formed therein, the plurality of channels being dimensioned and configured to communicate a portion of the quantity of the nucleation initiator into the inner volume of the nucleation chamber. In some embodiments, the one or more electrospray nozzles comprises a plurality of electrospray nozzles in a same plane, and wherein respective of the plurality of electrospray nozzles in the same plane are oriented in different directions. In some embodiments, the one or more electrospray nozzles comprise one or more electrodes configured to charge the nucleation initiator prior to or while dispersing the nucleation initiator into the inner volume of the nucleation chamber. In some embodiments, at least a portion of an inner surface of the nucleation chamber comprises or is coated with one of: a hydrophilic material, a hydrophobic material, a superhydrophobic material, an oleophobic material, an oleophilic material, a polymer, noble metals, rare-earth oxides, or organic monolayers.

In some embodiments, the AWG device can further comprise: a condensation region within a bottom portion of the inner volume of the nucleation chamber, wherein the condensation region is configured to cause condensation of the water droplets formed about the one or more particles or droplets of the nucleation initiator. In some embodiments, a geometry of the bottom portion of the inner volume of the nucleation chamber is configured to cause one of: drop-wise condensation, film-wise condensation, droplet aggregation, droplet gravity collection, droplet shear collection, or condensate film flow along a condensing surface. In some embodiments, a relative humidity of the volume of the gas is greater than about 30% before the volume of the gas is communicated into the inner volume of the nucleation chamber.

In some embodiments, the AWG device can further comprise: a cooling element/device configured to decrease a temperature of the volume of the gas to between about 33° F. and about 75° F. In some embodiments, the nucleation initiator comprises one or more of: CaCl₂, NaCl, LiCl, MgCl₂, KCOOH, CH₃COOK, or sulfates. In some embodiments, the AWG device can further comprise: one or more condensation enhancement structures disposed within a bottom portion of the inner volume of the nucleation chamber, the one or more condensation enhancement structures configured to increase a rate of condensation of the water droplets formed about the one or more particles or droplets of the nucleation initiator. In some embodiments, the one or more condensation enhancement structures comprise one or more of: baffles, perforated baffles, plates, perforated plates, static mixers, tabs, columns, dividers, porous structures, vertical structures, textured surfaces, lubricious surfaces, or liquid-impregnated surfaces.

According to another embodiment, an atmospheric water generation (AWG) system can be provided, the AWG system comprising: a nucleation chamber having an outer shell defining an inner volume, the nucleation chamber comprising: a first inlet through the outer shell of the nucleation chamber to direct a volume of a gas into a cyclonic pathway in the inner volume of the nucleation chamber; at least one electrospray nozzle positioned within the inner volume of the nucleation chamber, wherein the at least one electrospray nozzle is configured to disperse a nucleation initiator into the inner volume of the nucleation chamber to cause nucleation of water droplets from water vapor in the volume of gas about one or more particles or droplets of the nucleation initiator to form an aqueous product; and an aqueous product outlet disposed through the outer shell of the nucleation chamber, wherein the aqueous product outlet is configured to direct at least a portion of the aqueous product out of the nucleation chamber; the AWG system further comprising a separation module in fluidic communication with the aqueous product outlet of the nucleation chamber, the separation module being configured to separate the aqueous product into a retentate and an aqueous filtrate, the retentate comprising at least a portion of the nucleation initiator.

In some embodiments, the separation module comprises one or more of: membrane filtration, microfiltration, nanofiltration, ultrafiltration, reverse osmosis, forward osmosis, distillation, gas separation, electrodialysis, electrode ionization, electro filtration, fuel cell, membrane distillation, evaporation, crystallization, ion exchange, electrodialysis reversal, capacitive deionization, centrifugal separation, or graphene size-exclusion membrane filtration. In some embodiments, the nucleation initiator comprises a salt, a desiccant material, a hygroscopic material, an ionic liquid, or water droplets. In some embodiments, the AWG system can further comprise: a dehumidified air outlet formed through the outer shell of the nucleation chamber, the dehumidified air outlet being configured to communicate the volume of the gas out of the nucleation chamber. In some embodiments, the AWG system can further comprise: one or more carbon capture cartridges or carbon capture tanks in fluidic communication with the dehumidified air outlet and configured to remove carbon-containing materials from the volume of the gas after being communicated out of the nucleation chamber.

In some embodiments, the cyclonic pathway is defined at least in part by a concave shape of an inner surface of the nucleation chamber. In some embodiments, the shape of the inner surface of the nucleation chamber is one or more of: cylindrical, conical, spherical, columnar, pyramidal, prismatic, cubic, a torus, polyhedra, an octagonal prism, tetrahedra, octahedra, dodecahedra, icosahedra, irregularly prismatic, or irregularly pyramidal. In some embodiments, one or more electrospray nozzles are at least partially disposed in one or more apertures extending at least partially through the outer shell of the nucleation chamber. In some embodiments, each of the one or more electrospray nozzles define a plurality of channels formed therein, the plurality of channels being dimensioned and configured to communicate a portion of the quantity of the nucleation initiator into the inner volume of the nucleation chamber. In some embodiments, the one or more electrospray nozzles comprises a plurality of electrospray nozzles in a same plane, and wherein respective of the plurality of electrospray nozzles in the same plane are oriented in different directions.

In some embodiments, the one or more electrospray nozzles comprise one or more electrodes configured to charge the nucleation initiator prior to or while dispersing the nucleation initiator into the inner volume of the nucleation chamber. In some embodiments, at least a portion of an inner surface of the nucleation chamber comprises or is coated with one of: a hydrophilic material, a hydrophobic material, a superhydrophobic material, an oleophobic material, an oleophilic material, a polymer, noble metals, rare-earth oxides, or organic monolayers. In some embodiments, the nucleation chamber further comprises: a condensation region within a bottom portion of the inner volume of the nucleation chamber, wherein the condensation region is configured to cause condensation of the water droplets formed about the one or more particles or droplets of the nucleation initiator. In some embodiments, a geometry of the bottom portion of the inner volume of the nucleation chamber is configured to cause one of: drop-wise condensation, film-wise condensation, droplet aggregation, droplet gravity collection, droplet shear collection, or condensate film flow along a condensing surface.

In some embodiments, a relative humidity of the volume of the gas is greater than about 30% before the volume of the gas is communicated into the inner volume of the nucleation chamber. In some embodiments, the nucleation chamber further comprises: a cooling element/device configured to decrease a temperature of the volume of the gas to between about 33° F. and about 75° F. In some embodiments, the nucleation initiator comprises one or more of: CaCl₂, NaCl, LiCl, MgCl₂, KCOOH, CH₃COOK, or sulfates. In some embodiments, the nucleation chamber further comprises: one or more condensation enhancement structures disposed within a bottom portion of the inner volume of the nucleation chamber, the one or more condensation enhancement structures configured to increase a rate of condensation of the water droplets formed about the one or more particles or droplets of the nucleation initiator. In some embodiments, the one or more condensation enhancement structures comprise one or more of: baffles, perforated baffles, plates, perforated plates, static mixers, tabs, columns, dividers, porous structures, vertical structures, textured surfaces, lubricious surfaces, or liquid-impregnated surfaces.

According to another embodiment, a method for atmospheric water generation (AWG) can be carried out, the method comprising: communicating a volume of a gas into an inner volume of a nucleation chamber such that the volume of the gas travels along a cyclonic pathway within the inner volume of the nucleation chamber; dispersing, using at least one electrospray nozzle positioned within the inner volume of the nucleation chamber, while the volume of the gas travels along the cyclonic pathway within the inner volume of the nucleation chamber, a nucleation initiator into the inner volume of the nucleation chamber, to cause nucleation of water droplets from water vapor in the volume of the gas about one or more particles or droplets of the nucleation initiator, thereby forming an aqueous product and a volume of dehumidified gas; communicating the volume of the dehumidified gas out of the nucleation chamber through a first outlet of the nucleation chamber; communicating the aqueous product out of the nucleation chamber through a second outlet of the nucleation chamber; and separating the aqueous product, using a separation module, after the aqueous product is communicated out of the nucleation chamber, into a retentate and an aqueous filtrate, the retentate comprising at least a portion of the nucleation initiator.

In some embodiments, the nucleation initiator comprises a salt, a desiccant material, a hygroscopic material, an ionic liquid, or water droplets. In some embodiments, the method can further comprise: capturing, using one or more carbon capture cartridges or carbon capture tanks in fluidic communication with the nucleation chamber, carbon-containing materials from the volume of the dehumidified gas after being communicated out of the nucleation chamber. In some embodiments, the cyclonic pathway is defined at least in part by a concave shape of an inner surface of the nucleation chamber.

In some embodiments, the method can further comprise: returning the portion of the nucleation initiator in the retentate to a nucleation initiator reservoir in fluidic communication with the nucleation chamber such that the portion of the nucleation initiator in the retentate is available to be dispersed again within the inner volume of the nucleation chamber to cause nucleation of water droplets from water vapor in a subsequent volume of the gas.

In some embodiments, the method can further comprise: electrically charging the nucleation initiator prior to dispersing the nucleation initiator into the inner volume of the nucleation chamber while the volume of the gas travels along the cyclonic pathway.

In some embodiments, the method can further comprise: condensing, in a condensation region within a bottom portion of the inner volume of the nucleation chamber, the water droplets formed about the one or more particles or droplets of the nucleation initiator, thereby forming the aqueous product.

In some embodiments, a relative humidity of the volume of the gas is greater than about 30%. In some embodiments, the relative humidity of the dehumidified gas is less than about 20%.

In some embodiments, the method can further comprise: cooling the volume of the gas, before the volume of the gas is communicated into the nucleation chamber, using a cooling element/device configured to decrease a temperature of the volume of the gas to between about 33° F. and about 75° F. In some embodiments, the nucleation initiator comprises one or more of: CaCl₂, NaCl, LiCl, MgCl₂, KCOOH, CH₃COOK, or sulfates.

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. An atmospheric water generation (AWG) device, the AWG device comprising:
a nucleation chamber having an outer shell defining an inner volume;
a first inlet through the outer shell of the nucleation chamber to direct a volume of a gas into a cyclonic pathway in the inner volume of the nucleation chamber;
at least one electrospray nozzle positioned within the inner volume of the nucleation chamber, wherein the at least one electrospray nozzle is configured to disperse a nucleation initiator into the inner volume of the nucleation chamber to cause nucleation of water droplets from water vapor in the volume of gas about one or more particles or droplets of the nucleation initiator to form an aqueous product; and
an aqueous product outlet disposed through the outer shell of the nucleation chamber, wherein the aqueous product outlet is configured to direct at least a portion of the aqueous product out of the nucleation chamber.

2. The AWG device of claim 1, further comprising:
a separation module configured to separate the aqueous product into a water-based permeate and a concentrate.

3. (canceled)

4. The AWG device of claim 1, wherein the nucleation initiator comprises a salt, a desiccant material, a hygroscopic material, an ionic liquid, or water droplets.

5. The AWG device of claim 1, further comprising:
a dehumidified air outlet formed through the outer shell of the nucleation chamber, the dehumidified air outlet being configured to communicate the volume of the gas out of the nucleation chamber.

6. (canceled)

7. The AWG device of claim 1, wherein the cyclonic pathway is defined at least in part by a concave shape of an inner surface of the nucleation chamber.

8. (canceled)

9. The AWG device of claim 1, wherein one or more electrospray nozzles are at least partially disposed in one or more apertures extending at least partially through the outer shell of the nucleation chamber.

10. The AWG device of claim 1, wherein each of the one or more electrospray nozzles define a plurality of channels formed therein, the plurality of channels being dimensioned and configured to communicate a portion of the quantity of the nucleation initiator into the inner volume of the nucleation chamber.

11. The AWG device of claim 1, wherein the one or more electrospray nozzles comprises a plurality of electrospray nozzles in a same plane, and wherein respective of the plurality of electrospray nozzles in the same plane are oriented in different directions.

12. The AWG device of claim 1, wherein the one or more electrospray nozzles comprise one or more electrodes configured to charge the nucleation initiator prior to or while dispersing the nucleation initiator into the inner volume of the nucleation chamber.

13. The AWG device of claim 1, wherein at least a portion of an inner surface of the nucleation chamber comprises or is coated with one of: a hydrophilic material, a hydrophobic material, a superhydrophobic material, an oleophobic material, an oleophilic material, a polymer, noble metals, rare-earth oxides, organic monolayers,

14. The AWG device of claim 13, further comprising:
a condensation region within a bottom portion of the inner volume of the nucleation chamber, wherein the condensation region is configured to cause condensation of the water droplets formed about the one or more particles or droplets of the nucleation initiator.

15-16. (canceled)

17. The AWG device of claim 1, further comprising:
a cooling element/device configured to decrease a temperature of the volume of the gas to between about 33° F. and about 75° F.

18. The AWG device of claim 1, wherein the nucleation initiator comprises one or more of: CaCl₂, NaCl, LiCl, MgCl₂, KCOOH, CH₃COOK, or sulfates.

19. The AWG device of claim 1, further comprising:
one or more condensation enhancement structures disposed within a bottom portion of the inner volume of the nucleation chamber, the one or more condensation enhancement structures configured to increase a rate of condensation of the water droplets formed about the one or more particles or droplets of the nucleation initiator.

20. (canceled)

21. An atmospheric water generation (AWG) system, the AWG system comprising:
a nucleation chamber having an outer shell defining an inner volume, the nucleation chamber comprising:
a first inlet through the outer shell of the nucleation chamber to direct a volume of a gas into a cyclonic pathway in the inner volume of the nucleation chamber;
at least one electrospray nozzle positioned within the inner volume of the nucleation chamber, wherein the at least one electrospray nozzle is configured to disperse a nucleation initiator into the inner volume of the nucleation chamber to cause nucleation of water droplets from water vapor in the volume of gas about one or more particles or droplets of the nucleation initiator to form an aqueous product; and
an aqueous product outlet disposed through the outer shell of the nucleation chamber, wherein the aqueous product outlet is configured to direct at least a portion of the aqueous product out of the nucleation chamber;
a separation module in fluidic communication with the aqueous product outlet of the nucleation chamber, the separation module being configured to separate the aqueous product into a retentate and an aqueous filtrate, the retentate comprising at least a portion of the nucleation initiator.

22. (canceled)

23. The AWG system of claim 21, wherein the nucleation initiator comprises a salt, a desiccant material, a hygroscopic material, an ionic liquid, or water droplets.

24-25. (canceled)

26. The AWG system of claim 21, wherein the cyclonic pathway is defined at least in part by a concave shape of an inner surface of the nucleation chamber.

27. (canceled)

28. The AWG system of claim 21, wherein one or more electrospray nozzles are at least partially disposed in one or more apertures extending at least partially through the outer shell of the nucleation chamber.

29-35. (canceled)

36. The AWG system of claim 21, wherein the nucleation chamber further comprises:
a cooling element configured to decrease a temperature of the volume of the gas to between about 33° F. and about 75° F.

37-39. (canceled)

40. A method for atmospheric water generation (AWG), the method comprising:
communicating a volume of a gas into an inner volume of a nucleation chamber such that the volume of the gas travels along a cyclonic pathway within the inner volume of the nucleation chamber;
dispersing, using at least one electrospray nozzle positioned within the inner volume of the nucleation chamber, while the volume of the gas travels along the cyclonic pathway within the inner volume of the nucleation chamber, a nucleation initiator into the inner volume of the nucleation chamber, to cause nucleation of water droplets from water vapor in the volume of the gas about one or more particles or droplets of the nucleation initiator, thereby forming an aqueous product and a volume of dehumidified gas;
communicating the volume of the dehumidified gas out of the nucleation chamber through a first outlet of the nucleation chamber;
communicating the aqueous product out of the nucleation chamber through a second outlet of the nucleation chamber;
separating the aqueous product, using a separation module, after the aqueous product is communicated out of the nucleation chamber, into a retentate and an aqueous filtrate, the retentate comprising at least a portion of the nucleation initiator.

41-50. (canceled)
